(19) United States
(12) Patent Application Publication
(10) Pub. No.: US 2015/0138447 A1
(43) Pub. Date: May 21, 2015

(54) LIGHTING DEVICE, DISPLAY DEVICE, AND TELEVISION DEVICE

(71) Applicant: Sharp Kabushiki Kaisha, Osaka-shi, Osaka (JP)

(72) Inventor: Hirokazu Mouri, Osaka-shi (JP)

(21) Appl. No.: 14/408,030

(22) PCT Filed: Jun. 27, 2013
(86) PCT No.: PCT/JP2013/067647

§ 371 Date: Dec. 15, 2014

(30) Foreign Application Priority Data
Jul. 3, 2012 (JP) 2012-149758

(51) Int. Cl. F21V 8/00; H04N 5/66

(52) U.S. Cl. CPC G02B 6/0091; G02B 6/0088; H04N 5/66
USPC 348/790; 362/611; 349/65

(57) ABSTRACT

A liquid crystal display device 10 includes LEDs 17, a light guide plate 16, a mating portion 33, a positioning portion 34, a heat dissipation member 19 on which the LEDs 17 are mounted, and a restriction portion 35. The light guide plate 16 includes a peripheral surface facing the LEDs 17 and configured as a light entrance surface 16b through which light from the LEDs 17 enters and a plate surface configured as a light exit surface 16a through which light exits. The mating portion 33 protrudes from a portion of a peripheral surface 16e of the light guide plate 16 adjacent to the light entrance surface 16b or is a recess formed in the peripheral surface 16e adjacent to the light entrance surface 16b. The positioning portion 34 is fitted with the mating portion 33 as a protrusion and recess fitting such that the light guide plate 16 is positioned with respect to an arrangement direction of the LEDs 17 and the light guide plate 16. The restriction portion 35 is included in the heat dissipation member 19 and sandwiched between first side-walls 33a, 34a of the mating portion 33 and the positioning portion 34 opposite to each other in the arrangement direction to restrict a distance between the LEDs 17 and the light entrance surface 16b.

### TECHNICAL FIELD

The present invention relates to a lighting device, a display device, and a television device.

### BACKGROUND ART

In recent years, displays in image display devices, such as television devices, are being shifted from conventional cathode-ray tube displays to thin displays, such as liquid crystal displays and plasma displays. With the thin displays, thicknesses of the image display devices can be decreased. Liquid crystal panels do not emit light. Therefore, liquid crystal display devices including liquid crystal panels require backlight devices. The backlight devices are classified broadly into a direct type and an edge-light type based on mechanisms. For further reduction in thicknesses of the liquid crystal display devices, the edge-light type backlight devices are more preferable. A backlight device disclosed in Patent Document 1 is known as an example of the kind.

### RELATED ART DOCUMENT

### Patent Document

Patent Document 1: Japanese Unexamined Patent Publication No. 2011-243554

### Problem to be Solved by the Invention

The above edge-light type backlight device may have a configuration in which a light source is mounted on a heat dissipation member and the heat dissipation member is mounted to a chassis and a light guide plate is arranged inside the chassis. According to the configuration, errors may occur in position of the light source relative to the heat dissipation member, position of the heat dissipation member relative to the chassis, and position of the light guide plate relative to the chassis during the mounting. These errors in positions may increase variations in positions between light sources and light guide plates. Accordingly, light entrance efficiency of light from the light sources entering a light entrance surface of the light guide plate may decrease or vary, and thus brightness of light exiting the light guide plate through a light exit surface may decrease or vary.

### DISCLOSURE OF THE PRESENT INVENTION

The technology disclosed herein was made in view of the above circumstances. An object is to increase brightness and to reduce uneven brightness.

### Means for Solving the Problem

A lighting device according to this invention includes a light source, a light guide plate, a mating portion, a positioning portion, a light source mounting member on which the light source is mounted, a restriction portion. The light guide plate includes a peripheral surface and a plate surface. The peripheral surface faces the light source and is configured as a light entrance surface through which light from the light source enters the light guide plate. The plate surface is configured as a light exit surface through which light exits the light guide plate. The mating portion protrudes from a portion of a peripheral surface of the light guide plate or is a recess formed therein. The peripheral surface is adjacent to the light entrance surface of the light guide plate. The positioning portion is for positioning the light guide plate with respect to an arrangement direction of the light source and the light guide plate with the positioning and the portion fitted together. The restriction portion is included in the light source mounting member for controlling a distance between the light source and the light entrance surface and sandwiched between opposing surfaces of the mating portion and the positioning portion opposite to each other in the arrangement direction. The restriction portion is configured to restrict.

In this configuration, light emitted from the light source enters the light entrance surface of the light guide plate, travels inside the light guide plate, and exits through the light exit surface. The mating portion is located at a portion of the peripheral surface of the light guide plate adjacent to the light entrance surface of the light guide plate. The positioning portion is fitted with the mating portion as a protrusion and recess fitting, and thus the position of the light guide plate is fixed in the arrangement direction of the light source and the light guide plate. The restriction portion of the light source mounting member is sandwiched between the opposing surface of the positioning portion and the opposing surface of the mating portion opposite to each other in the arrangement direction. With this configuration, the distance between the light source, which is mounted on the light source mounting member including the restriction portion, and the light entrance surface of the light guide plate. Namely, the position of the light source with respect to the light entrance surface of the light guide plate is fixed by the positioning portion and the mating portion, which are for fixing the position of the light guide plate in the arrangement direction. Therefore, the positional relation between the light source and the light entrance surface is fixed with high accuracy. With this configuration, light entrance efficiency of light that exits the light source and enters the light entrance surface is improved and maintained. Thus, brightness of exiting light through the light exit surface is increased and brightness of the exiting light is less likely to be uneven.

The following configurations may be preferably employed as embodiments of the present invention.

(1) The mating portion may protrude from the peripheral surface of the light guide plate adjacent to the light entrance surface of the light guide plate. The positioning portion may have a recessed shape corresponding to an outline of the mating portion. In this configuration, the mating portion protrudes from the peripheral surface of the light guide plate that is adjacent to the light entrance surface of the light guide plate. The positioning portion has a recessed shape corresponding to the outline of the mating portion. The restriction portion is sandwiched between the opposing surfaces facing to each other in the arrangement direction. Namely, the restriction portion is outward with respect to the peripheral surface of the light guide plate adjacent to the light entrance surface. In comparison to a configuration in which the mating portion is a recess formed in the peripheral surface, the restriction portion is less likely to block light traveling inside the light guide plate. Therefore, light use efficiency is improved. This configuration is preferable for increasing the brightness, and more preferable for reducing uneven brightness.

(2) The positioning portion and the mating portion may include one pair of the opposing surfaces closer to the light source and another pair of the opposing surfaces away from the light source with respect to the arrangement direction. The restriction portion is sandwiched between the opposing surfaces of the positioning portion and the mating portion closer to the light source. In comparison to a configuration in which a restriction portion is sandwiched between the opposing surfaces of the positioning portion and the mating portion away from the light source, the length of the restriction portion from the light source mounting member can be reduced. Therefore, dimensional errors of the restriction portion can be reduced and the distance between the light source and the light entrance surface is properly controlled by the restriction portion.

(3) The mating portion may be located close to a light source side of the peripheral surface of the light guide plate that is adjacent to the light entrance surface of the light guide plate. If the light guide plate thermally expands or contracts, the light guide plate expands or contracts with the positioning portion and the mating portion as an origin. The mating portion is located closer to the light source side of the peripheral surface of the light guide plate that is adjacent to the light entrance surface. Therefore, the variation in position of the light entrance surface due to thermal expansion or contraction is reduced. Accordingly, a variation in light entrance efficiency of light that exits the light source and enters the light entrance surface of the light guide plate can be reduced. This configuration is more preferable for reducing uneven brightness. Furthermore, the length of the restriction portion from the light source mounting member can be reduced. Therefore, errors in positions of the restriction portion can be reduced and thus the distance between the light source and the light entrance surface is properly controlled by the restriction portion.

(4) The lighting device may further include a positioning member including an opposing surface. The opposing surface may be opposite the peripheral surface of the light guide plate adjacent to the light entrance surface. The positioning portion may be a recess formed in a portion of the opposing surface of the positioning member or a protrusion protruding from a portion of the opposing surface of the positioning member. In this configuration, because the positioning member includes the opposing surface opposite the peripheral surface of the light guide plate that is adjacent to the light entrance surface of the light guide plate, light that leaks through the peripheral surface of the light guide plate can be blocked by the opposing surface. Therefore, light use efficiency can be improved. This configuration is preferable for increasing brightness. In this embodiment, the opposing surface of the positioning member is opposite the peripheral surface of the light guide plate adjacent to the light entrance surface. The positioning portion is located at a portion of the opposing surface of the positioning member and fitted with the mating portion located at a portion of the peripheral surface of the light guide plate. Therefore, the position of the light guide plate is fixed in the arrangement direction.

(5) The lighting device may further includes a light source board including an opposing surface opposite the light entrance surface. The light source may include a plurality of light sources that are arranged in a line on the opposing surface of the light source board. The light source mounting member may have a plate-like shape extending along a plate surface of the light source board and may be attached to the light source board so as to contact a plate surface of the light source board on an opposite side from the light sources. The restriction portion may protrude from the light source mounting member toward the light guide plate at an end with respect to a direction in which the light source mounting member extends. With this configuration, the light source is mounted on the light source mounting member having a plate-like shape and extending parallel to the plate surface of the light source board, and the restriction portion protrudes from the end of the extension dimension of the light source mounting member toward the light guide plate 16. Therefore, a distance between the light source and the light entrance surface is controlled.

(6) The light source board may have an elongated shape and a power feeding component for feeding power to the light sources is disposed at an end of a long dimension of the light source board. The restriction portion may include a lateral portion and a restriction piece. The lateral portion may protrude from the end of the light source mounting member toward the light guide plate and may be located beside the light source board and the power feeding component. The restriction piece may extend from a distal end of the protruded lateral portion at an angle and may be sandwiched between the opposing surfaces of the positioning portion and the mating portion opposite to each other in the arrangement direction. In this configuration, power is fed to the light source through the power feeding component disposed on the longitudinal end of the light source board. The lateral portion of the restriction portion protrudes from the end of the light source mounting member toward the light guide plate and is located beside the light source board and the power feeding component. With this configuration, the power feeding component can be protected. Furthermore, the restriction piece bends at the distal end of the lateral portion and sandwiched between the opposing surfaces of the positioning portion and the mating portion opposite to each other in the arrangement direction. Therefore, the distance between the light source and the light entrance surface is controlled.

(7) The light guide plate may include a cutout in a part of an end portion including the light entrance surface. The cutout is for receiving the power feeding component. The mating portion may be arranged adjacent to the cutout. In this configuration, the end portion of the light guide plate including the light entrance surface has the cutout at a part thereof to receive the board connector. In comparison to a case in which the power feeding component is disposed between the light entrance surface and the light source board without a cutout, a distance between the light source and the light entrance surface can be reduced. Thus, light entrance efficiency of light that enters the light entrance surface can be improved. Furthermore, because the mating portion is adjacent to the cutout, light exiting the light source and traveling toward the mating portion is more likely to be blocked by the power feeding component before light reaches the mating portion. Therefore, light is less likely to leak from the mating portion and uneven brightness is suitably reduced.

To resolve the problem described earlier, a display device according to the technology includes the lighting device described above and a display panel configured to provide a display using light from the lighting device.

According to such a display device, the lighting device configured to provide light to the display panel emits light with high brightness and is less likely to produce uneven brightness. Therefore, the display device can perform high quality image display.

Examples of the display panel include a liquid crystal display panel. The display device may be adapted to various purposes such as television devices and display devices of personal computers. Preferable purposes include large screen display devices.

### Advantageous Effect of the Invention

According to the technology, brightness can be increased and uneven brightness can be reduced.

### BRIEF DESCRIPTION OF THE DRAWINGS

FIG. 1 is an exploded perspective view illustrating a general configuration of a television device and a liquid crystal display device according to a first embodiment of the present invention.

FIG. 2 is a rear view of the television device and the liquid crystal display device.

FIG. 3 is an exploded perspective view illustrating a general configuration of a liquid crystal display unit included in the liquid crystal display device.

FIG. 4 is a cross-sectional view of the liquid crystal display device taken in a short-side direction thereof.

FIG. 5 is a cross-sectional view of the liquid crystal display device taken in a long-side direction thereof.

FIG. 6 is a magnified cross-sectional view of the liquid crystal display device. The liquid crystal display device is taken in the short-side direction thereof along a line passing a joint screw hole.

FIG. 7 is a magnified cross-sectional view of the liquid crystal display device. The liquid crystal display device is taken in the short-side direction along a line passing a heat dissipation member screw hole.

FIG. 8 is a magnified view of the cross-sectional view in FIG. 5.

FIG. 9 is a rear view of the liquid crystal display device without the chassis.

FIG. 10 is an exploded perspective view illustrating configurations of a restriction portion of a heat dissipation member, a mating portion of a light guide plate, and a positioning portion of a sub frame.

FIG. 11 is a rear view illustrating a plane arrangement of the restriction portion of the heat dissipation member, the mating portion of the light guide plate, and the positioning portion of the sub frame.

FIG. 12 is a cross-sectional view of FIG. 11.

FIG. 13 is a cross-sectional view illustrating a cross-sectional configuration of the liquid crystal display device taken in the short-side direction. The view is used to explain an assembly procedure of components included in a liquid crystal display unit that constitutes the liquid crystal display device.

FIG. 14 is a cross-sectional view illustrating a cross-sectional configuration of the liquid crystal display device taken in the long-side direction. The view illustrates an assembly procedure of the components included in the liquid crystal display unit that constitutes the liquid crystal display device.

FIG. 15 is a rear view illustrating a plane arrangement of a restriction portion of a heat dissipation member, a mating portion of a light guide plate, and a positioning portion of a sub frame according to a second embodiment.

FIG. 16 is a rear view illustrating a plane arrangement of a restriction portion of a heat dissipation member, a mating portion of a light guide plate, and a positioning portion of a sub frame according to a third embodiment.

FIG. 17 is a rear view illustrating a plane arrangement of a restriction portion of a light guide plate and an LED board according to a reference example.

### MODE FOR CARRYING OUT THE INVENTION

### First Embodiment

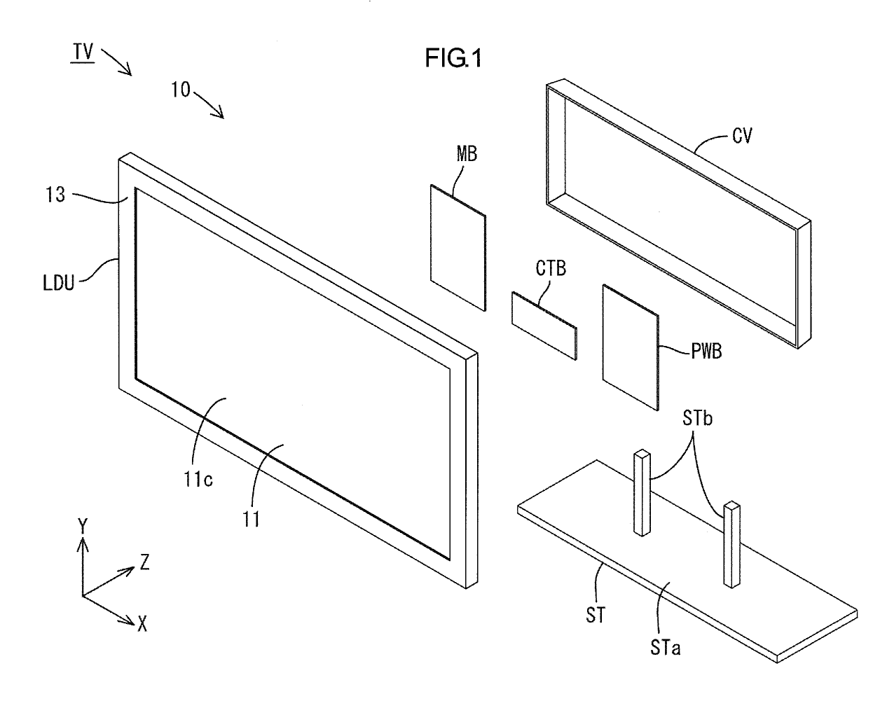

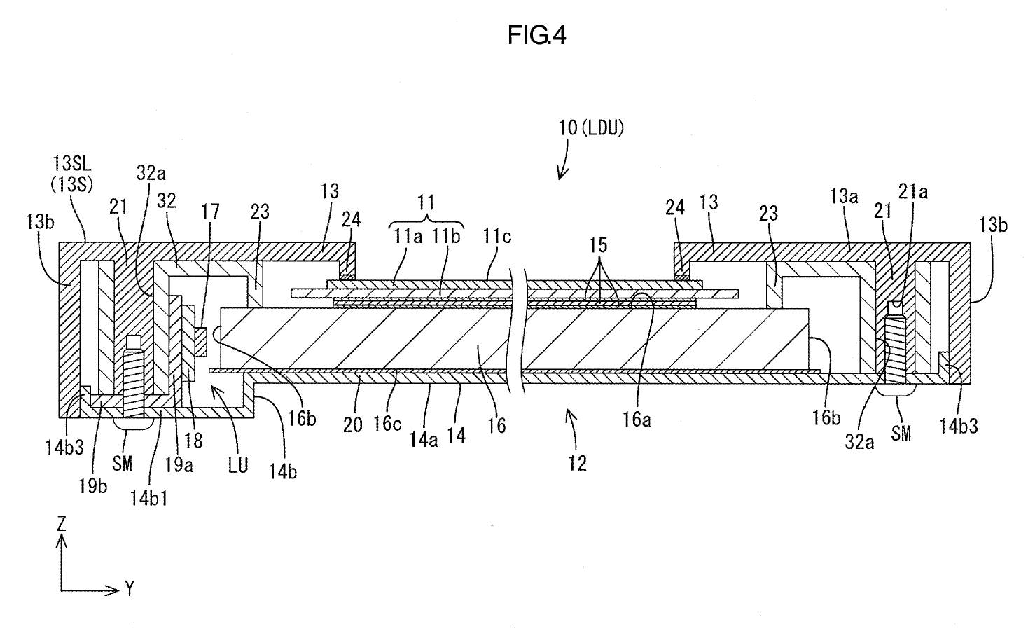

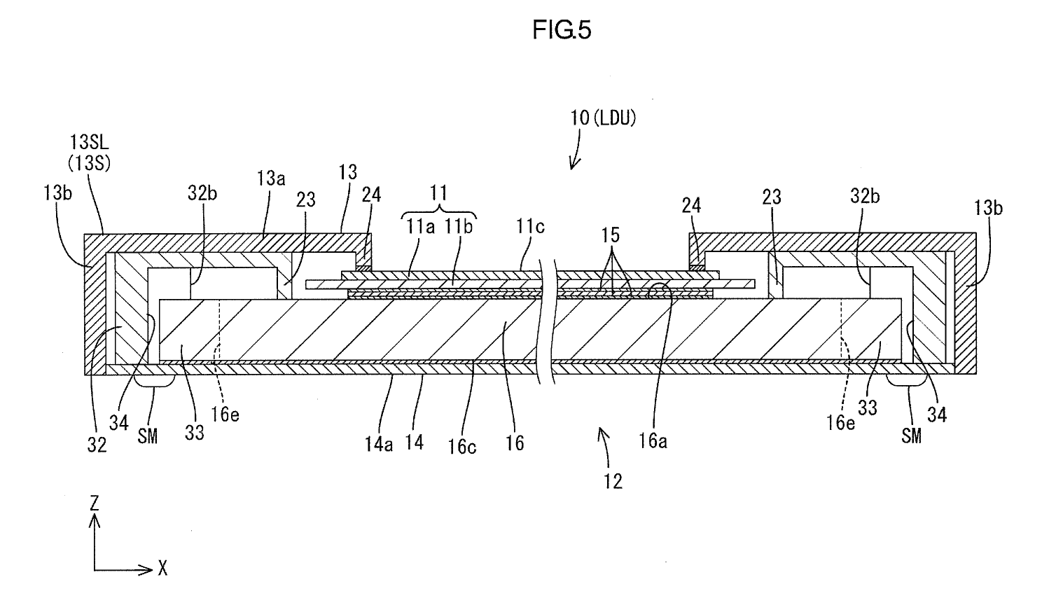

The first embodiment of this technology will be described with reference to FIGS. 1 to 14. In the following description, a liquid crystal display device 10 will be described. An X-axis, a Y-axis, and a Z-axis are present in some drawings. The axes in each drawing correspond to the respective axes in other drawings. The X-axes and Y-axes correspond to the horizontal direction and the vertical direction, respectively. In the following description, the upper side and the lower side in FIGS. 4 and 5 correspond to the front and the rear of the liquid crystal display device, respectively.

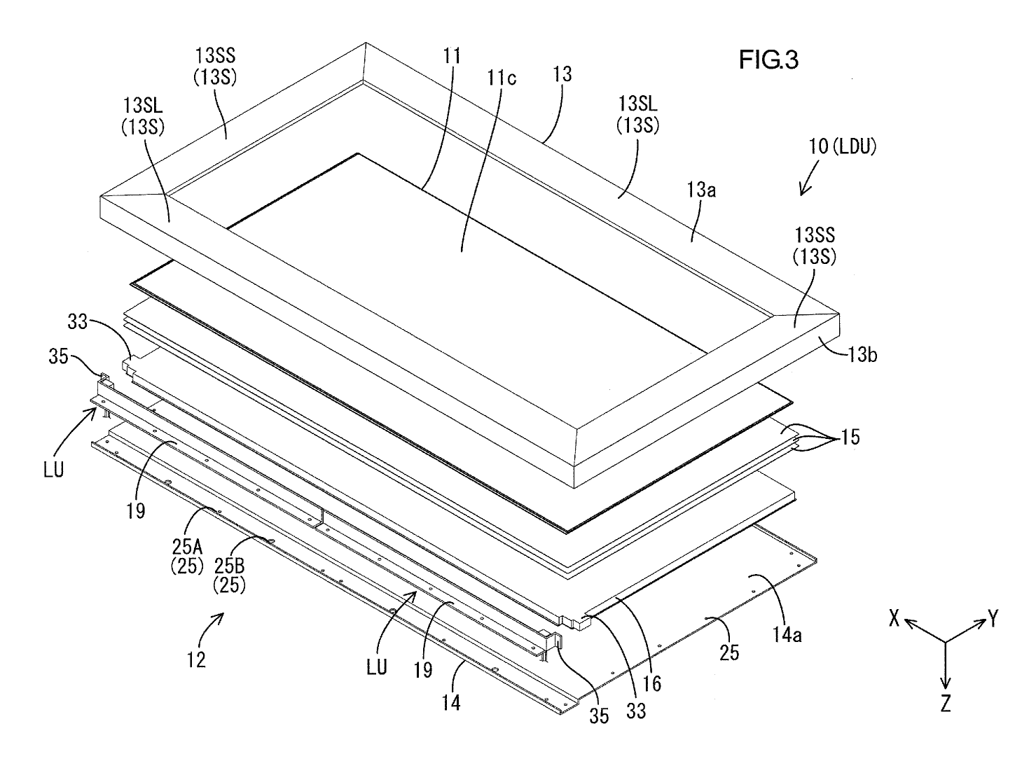

As illustrated in FIG. 1, a television device TV according to this embodiment includes a liquid crystal display unit (a display unit) LDU, boards PWB, MB, and CTB, a cover CV, and a stand ST. The boards PWB, MB, and CTB are attached on a rear surface (a back surface) of the liquid crystal display unit LDU. The cover CV is attached on a rear surface side of the liquid crystal display device 10 so as to cover the boards PWB, MB, and CTB. The stand ST supports the liquid crystal display unit LDU such that a display surface of the liquid crystal display unit LDU extends in the vertical direction (the Y-axis direction). The liquid crystal display device 10 according to this embodiment has the same configuration as the television device TV except for at least a component for receiving television signals (e.g. a tuner included in the main board MB). As illustrated in FIG. 3, the liquid crystal display unit LDU has a landscape rectangular shape (a rectangular shape, a longitudinal shape) as a whole. The liquid crystal display unit LDU includes a liquid crystal panel 11 as a display panel and a backlight unit (a lighting device) 12 as an external light source. The liquid crystal display device 10 includes a frame (a holding portion arranged on the display 11c side, one holding portion) 13 and a chassis (a holding portion on the side opposite to the display 11c side, another holding portion) 14 as exterior members that provide an appearance of the liquid crystal display device 10. The frame 13 and the chassis 14 hold the liquid crystal panel 11 and the backlight unit 12. In other words, the frame 13 and the chassis 14 constitute a holding member. The chassis 14 according to this embodiment is not only a part of the exterior member or the holding member but also a part of the backlight unit 12.

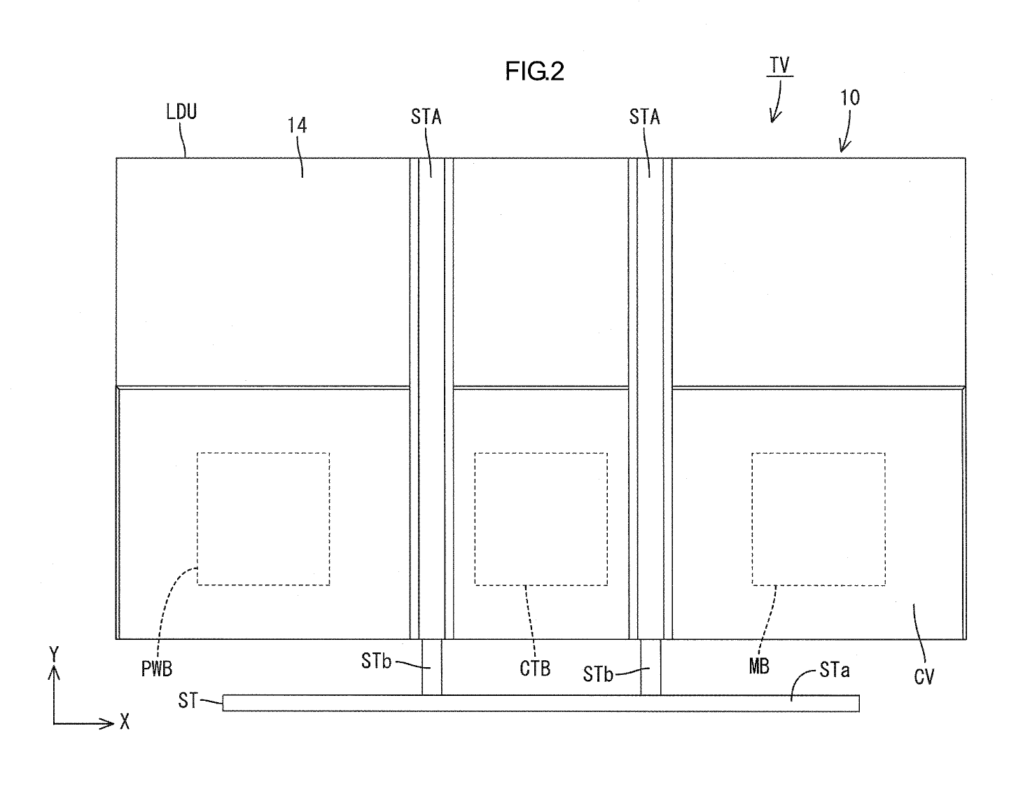

Configuration of the liquid crystal display device 10 on the rear surface side will be described. As illustrated in FIG. 2, two stand attachments STA are attached to a rear surface of the chassis 14. The rear surface of the chassis 14 provides a rear appearance of the liquid crystal display device 10. The stand attachments STA are away from each other in the X-axis direction and extend along the Y-axis direction on the chassis 14. Each stand attachment STA has a substantially channel-shaped cross section and is open to the chassis 14 so as to form a space with the chassis 14. Support portions STb of the stand ST are each inserted in the space between the respective stand attachments STA and the chassis 14. The stand ST includes a base STa and the support portions STb. The base STa extends parallel to the X-Z plane. The support portions STb stand on the base STa in the Y-axis direction. The cover CV is made of synthetic resin and attached to apart of the rear surface of the chassis 14. Specifically, as illustrated in FIG. 2, the cover CV covers a lower half part of the chassis 14 so as to cross over the stand attachments STA in the X-axis direction. A component storage space is provided between the cover CV and the chassis 14 such that the boards PWB, MB, and CTB, which will be described next, are stored therein.

As illustrated in FIG. 2, the boards PWB, MB, and CTB include a power source board PWB, a main board MB, and a control board CTB. The power source board PWB is a power supply source of the liquid crystal display device 10 and thus supplies drive power to the other boards MB and CTB and to LEDs 17 of the backlight unit 12. In other words, the power source board PWB also serves as “an LED drive board (a light source driving board, a power source) that drives the LEDs 17”. The main board MB includes at least a tuner and an image processor, which are not illustrated. The tuner is configured to receive television signals. The image processor performs image processing on the received television signals. The main board MB is configured to output the processed image signals to the control board CTB, which will be described later. If an external image reproducing device, which is not illustrated, is connected to the liquid crystal display device 10, image signals from the image reproducing device are input to the main board MB. The image processor included in the main board MB processes the image signals, and the main board MB outputs the processed image signals to the control board CTB. The control board CTB is configured to convert the image signals, which are sent from the main board MB, to driving signals for liquid crystals and to supply the driving signals to the liquid crystal panel 11.

As illustrated in FIG. 3, components of the liquid crystal display unit LDU included in the liquid crystal display device 10 are arranged in a space between the frame (a front frame) 13, which provides a front appearance, and the chassis (a rear chassis) 14, which provides a rear appearance. The main components housed in the space between the frame 13 and the chassis 14 at least include the liquid crystal panel 11, an optical member 15, a light guide plate 16, and LED units (light source units) LU. The liquid crystal panel 11, the optical member 15, and the light guide plate 16 are placed on top of one another and held between the frame 13 on the front side and the chassis 14 on the rear side. The backlight unit 12 includes the optical member 15, the light guide plate 16, the LED units LU, and the chassis 14. In other words, the liquid crystal display unit LDU without the liquid crystal panel 11 and the frame 13 is the backlight unit 12. The LED units LU of the backlight unit 12 are arranged in the space between the frame 13 and the chassis 14 along one of the long-side ends of the backlight unit 12. Specifically, the LED units LU are arranged along the long-side end on a lower side of the backlight unit 12 in the vertical direction (the Y-axis direction). That is, the LED units LU are arranged closer to one of long-side ends of the liquid crystal panel 11. The LED unit LU includes LEDs 17 as light sources, the LED board (a light source board) 18 on which the LEDs 17 are mounted, and a heat dissipation member (a light source mounting member) 19 to which the LED board 18 is mounted. Each component will be described next.

As illustrated in FIG. 3, the liquid crystal panel 11 has a landscape rectangular shape (a rectangular shape, a longitudinal shape) in a plan view. As illustrated in FIG. 4 and FIG. 5, the liquid crystal panel 11 includes a pair of glass substrates 11a and 11b and liquid crystals. The substrates 11a and 11b each having high light transmission properties are bonded together with a predetermined gap therebetween. The liquid crystals are sealed between the substrates 11a and 11b. One of the substrates 11a and 11b that is on the front side is a CF substrate 11a and the other one of the substrates 11a and 11b that is on the rear side (on the backside) is an array substrate 11b. On the array substrate 11b, switching elements (e.g. TFTs), pixel electrodes, and an alignment film are arranged. The switching elements are connected to gate lines and source lines that are arranged perpendicular to each other. The pixel electrodes are connected to the switching elements. On the CF substrate 11a, color filters, a counter electrode, and an alignment film are arranged. The color filters include red (R), green (G), and blue (B) color portions that are arranged in a predetermined arrangement. Polarizing plates, which are not illustrated, are arranged on outer sides of the substrates 11a and 11b.

As illustrated in FIGS. 4 and 5, the array substrate 11b, which is one of the substrates 11a and 11b of the liquid crystal panel 11, has a larger size in a plan view than the CF substrate 11a and is arranged such that ends of the array substrate 11b are farther out than respective peripheral portions of the CF substrate 11a. Specifically, the array substrate 11b is slightly larger than the CF substrates 11a such that the entire peripheral portions of the array board 11b are farther out than the peripheral portions of the CF substrate 11a. Multiple terminals extended from the gate lines and the source lines are arranged along one of long ends of the array substrate 11b. Flexible circuit boards (not illustrated) including drivers DR for controlling liquid crystals are connected to the terminals. Signals from the control board CTB are transmitted to the terminals via the flexible circuit boards. With the signals, images are displayed on the display surface 11c of and thus the liquid crystal panel 11.

As illustrated in FIG. 4 and FIG. 5, the liquid crystal panel 11 is placed on a front side (a light exit side) of the optical member 15, which will be described later. A rear surface of the liquid crystal panel 11 (a rear surface of the polarizing plate) is fitted to the optical member 15 with minimal gaps therebetween. Therefore, dust is less likely to enter between the liquid crystal panel 11 and the optical member 15. The display surface 11c of the liquid crystal panel 11 includes a display area and a non-display area. The display area is an inner area of a screen in which images are displayed. The non-display area is an outer area of the screen around the display area with a frame-like shape.

As illustrated in FIG. 3, the optical member 15 has a landscape rectangular shape in a plan view like the liquid crystal panel 11 and has about the same size (a short dimension and a long dimension) as the liquid crystal panel 11. The optical member 15 is placed on the front side (the light exit side) of the light guide plate 16, which will be described later, and sandwiched between the light guide plate 16 and the liquid crystal panel 11. The optical member 15 includes three sheets that are placed on top of one another. Each sheet of the optical member 15 may be any one selected from a diffuser sheet, a lens sheet, and a reflecting type polarizing sheet.

The light guide plate 16 is made of a substantially transparent (high light transmissivity) synthetic resin (e.g. acrylic resin or polycarbonate such as PMMA) which has a refractive index considerably higher than that of the air. As illustrated in FIG. 3, the light guide plate 16 has a landscape rectangular shape in a plan view similar to the liquid crystal panel 11 and the optical member 15. A thickness of the light guide plate 16 is larger than a thickness of the optical member 15. Along-side direction and a short-side direction of a plate surface of the light guide plate 16 correspond to the X-axis direction and the Y-axis direction, respectively. A thickness direction of the light guide plate 16 that is perpendicular to the plate surface corresponds to the Z-axis direction (an overlapping direction of the liquid crystal panel 11 and the light guide plate 16). The light guide plate 16 is arranged on the rear side of the optical member 15 and sandwiched between the optical member 15 and the chassis 14. As illustrated in FIGS. 4 and 5, a short dimension and a long dimension of the light guide plate 16 are larger than those of the liquid crystal panel 11 and the optical member 15. The light guide plate 16 is arranged such that four sides of the light guide plate 16 are farther out than four sides of the liquid crystal panel 11 and four sides of the optical member 15 (so as not to overlap each other in a plan view). With this configuration, the light from the LED 17 can travel proper distance inside the light guide plate 16. The ends of the light guide plate 16 from which the light may unevenly exit compared to the middle section thereof can be located outside the display area of the liquid crystal panel 11. The LED units LU are arranged on each side in the short-side direction so as to have the light guide plate 16 therebetween in the Y-axis direction. The light rays from the LEDs 17 enter the light guide plate 16 through the ends of the short dimension of the light guide plate 16. The light guide plate 16 is configured such that light rays, which are from the LEDs 17 and enter through the ends of the short dimension of the light guide plate 16, travel through the light guide plate 16 and exit toward the optical member 15 (the front side).

As illustrated in FIG. 4, one of the plate surfaces of the light guide plate 16 facing the front is a light exit surface 16a (a surface facing the optical member 15). Light exits the light guide plate 16 through the light exit surface 16a toward the optical member 15 and the liquid crystal panel 11. Peripheral surfaces of the light guide plate 16 that are adjacent to the plate surfaces of the light guide plate 16 include elongated long-side surfaces (peripheral surfaces in the short-side direction) that extend in the X-axis direction. One of the long-side surfaces on the lower side in the vertical direction is opposite the LEDs 17 (the LED boards 18) with a predetermined distance therebetween and serves as a light entrance surface 16b through which light from LEDs 17 enters. The light entrance surface 16b is parallel to the X-Z plane (plate surfaces of the LED boards 18) and substantially perpendicular to the light exit surface 16a. The light guide plate 16 includes a long-side portion including the light entrance surface 16b. The long-side portion includes cutouts 16d that are formed in corner portions of respective ends thereof. Each cutout 16d is for receiving the board connector 22 of each LED board 18, which will be described later. An arrangement direction of the LED 17 and the light entrance surface 16b correspond to the Y-axis direction and parallel to the light exit surface 16a.

As illustrated in FIGS. 4 and 5, a light guide reflection sheet (a reflection member) 20 is arranged on a rear side of the light guide plate 16, that is, a plate surface 16c opposite from the light exit surface 16a. Light that travels through the plate surface 16c toward the rear is reflected by the light guide reflection sheet 20 toward the front. The light guide reflection sheet 20 is arranged to cover an entire area of the plate surface 16c. In other words, the light guide reflection sheet 20 is arranged between the chassis 14 and the light guide plate 16. The light guide reflection sheet 20 is made of synthetic resin and has a white surface having high light reflectivity. As illustrated in FIGS. 4 and 5, the light guide reflection sheet 20 has a short-side dimension and a long-side dimension larger than those of the light guide plate 16. The light guide reflection sheet 20 is arranged such that four sides of the light guide reflection sheet 20 are farther out than the respective four sides of the light guide plate 16. Particularly, as illustrated in FIG. 4, a long-side portion of the light guide reflection sheet 20 close to the light entrance surface 16b of the light guide plate 16 is farther out than the light entrance surface 16b. Namely, the long-side portion of the light guide reflection sheet 20 protrudes toward the LEDs 17, and the protruded portion of the light guide reflection sheet 20 effectively reflects light traveling from the LEDs 17. With this configuration, efficiency of light that enters the light entrance surface 16b can be improved. At least one of the light exit surface 16a and the plate surface 16c opposite from the light exit surface 16a of the light guide plate 16 has a reflection portion (not illustrated) or a scattering portion (not illustrated). The reflection portion is configured to reflect the light inside the light guide plate 16. The scattering portion (not illustrated) is configured to scatter the light inside the light guide plate 16. The reflection portion or the scattering portion may be formed by patterning so as to have a specified in-plane distribution. This configuration regulates the light from the light exit surface 16a to have an even in-plane distribution.

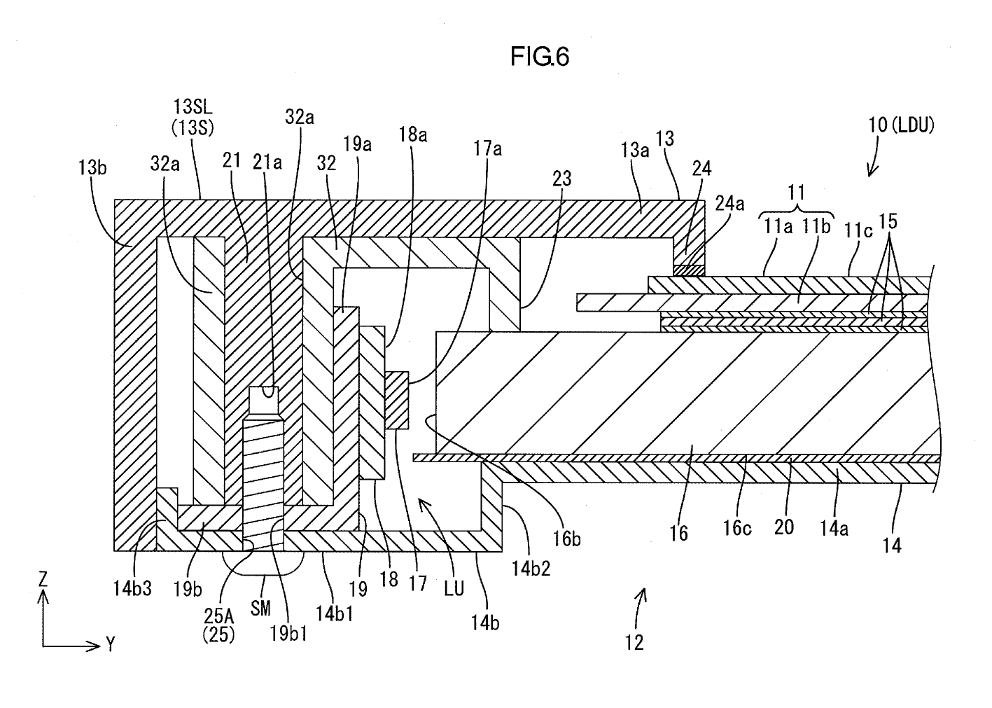

Next, a configuration of each of the LEDs 17, the LED board 18, and the heat dissipation member 19, which are included in the LED unit LU, will be described. As illustrated in FIGS. 3 and 4, each LED 17, which is included in the LED unit LU, include an LED chip that is sealed with resin on a board fixed on the LED board 18. The LED chip mounted on the board has one main light emission wavelength. Specifically, the LED chip that emits light in a single color of blue is used. On the other hand, the resin that seals the LED chip contains phosphors dispersed therein. The phosphors emit light in a predetermined color when excited by blue light emitted from the LED chip. Overall color of light emitted from the LED 17 is white. The phosphors may be selected, as appropriate, from yellow phosphors that emit yellow light, green phosphors that emit green light, and red phosphors that emit red light. The phosphors may be used alone or in combination of the above phosphors. The LED 17 includes a main light-emitting-surface 17a that is opposite to a surface on which the LED board 18 is mounted (a surface facing the light entrance surface 16b of the light guide plate 16). Namely, the LED 17 is a top-surface-emitting type LED (see FIG. 6 for the main light-emitting-surface 17a).

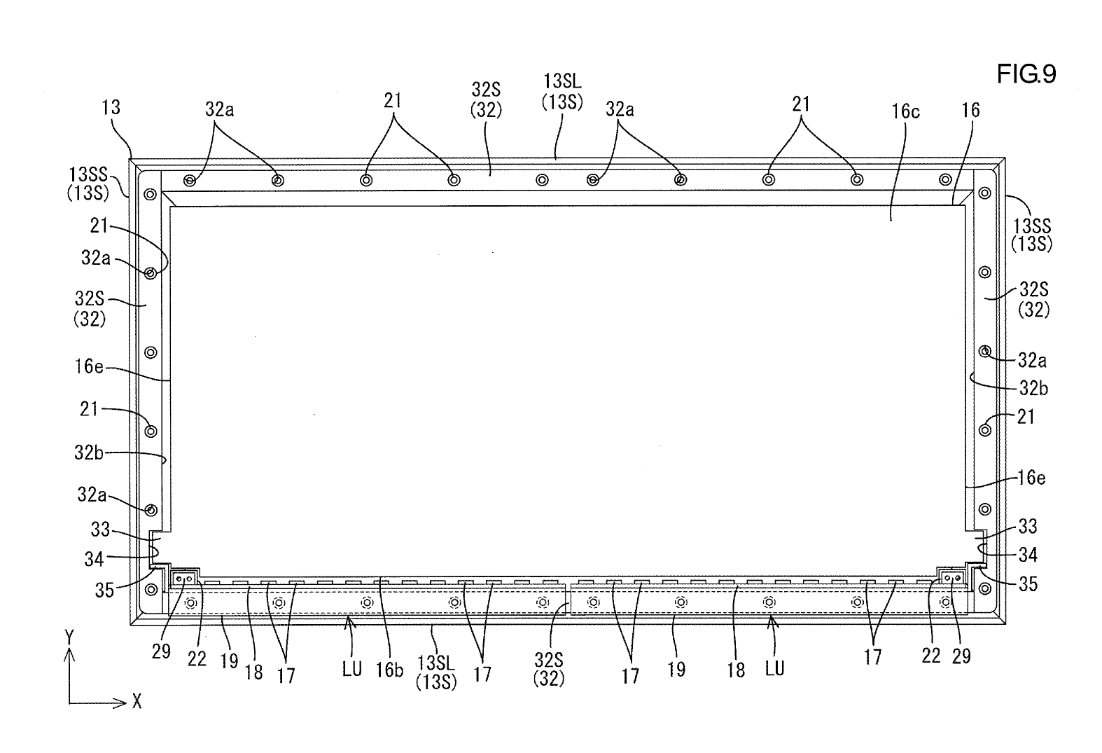

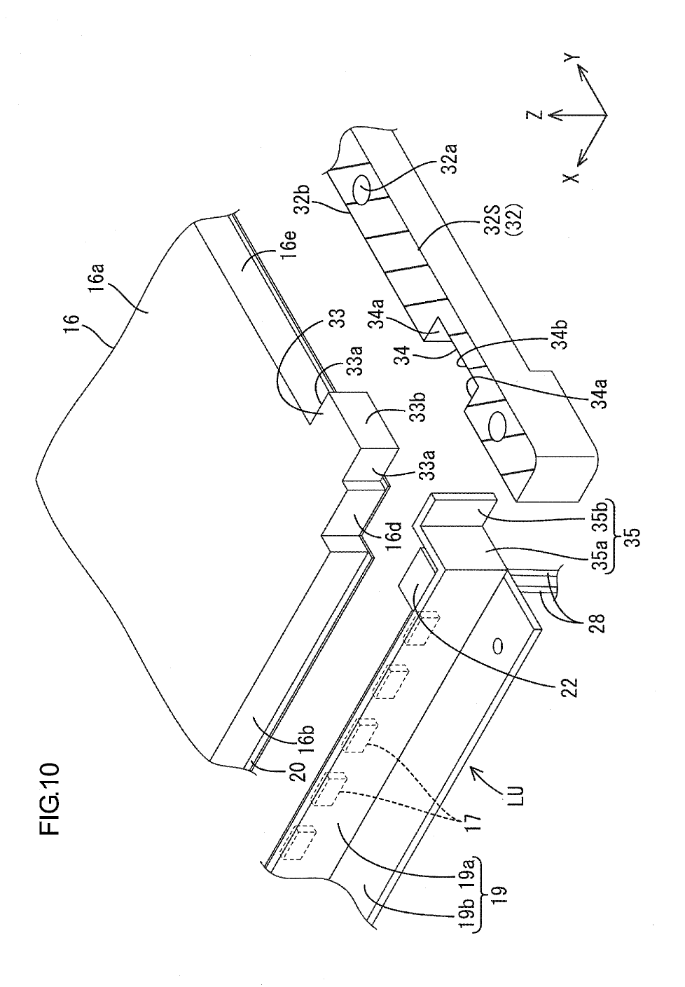

As illustrated in FIGS. 3 and 4, each LED board 18 included in the LED unit LU has an elongated plate-like shape and extends in the long-side direction of the light guide plate 16 (the X-axis direction, the long-side direction of the light entrance surface 16b). The LED board 18 is placed in the space between the frame 13 and the chassis 14 such that a board surface of each LED board 18 is parallel to the X-Z plane, namely, parallel to the light entrance surface 16b of the light guide plate 16. The LED board 18 has a long-side dimension that is about a half of the long-side dimension of the light guide plate 16. The LED board 18 includes a mount surface 18a on which the LEDs 17 are mounted. The mount surface 18a is a main board surface that faces inward, namely, a surface that faces the light guide plate 16 (the surface opposed to the light guide plate 16) (see FIG. 6 for the mount surface 18a). The LEDs 17 are arranged in a line (i.e., linearly) at intervals on the mount surface 18a of the LED board 18 along the long-side direction of the LED board 18 (the X-axis direction). In other words, multiple LEDs 17 are arranged apart from each other along the long-end portion of the backlight unit 12. Distances between the adjacent LEDs 17 in the X-axis direction are substantially equal, that is, the LEDs 17 are arranged at substantially equal intervals. Traces (not illustrated) are formed on the mount surface 18a of the LED board 18. Each trace extends in the longitudinal direction of the LED board 18 (the X-axis direction), that is, the direction in which the LEDs 17 are arranged. Each of the LEDs 17 is connected to the corresponding trace. Board connectors 22 are mounted (see FIGS. 9 and 10) on the mount surfaces 18a of the LED boards 18 at ends of the respective traces.

As illustrated in FIGS. 9 and 10, board connectors 22 are fitted together with relay connectors 29, respectively. The relay connectors 29 are connected to ends of relay wiring members 28, respectively. Each relay connector 29 is fitted in the corresponding board connector 22 from the rear side (i.e. the chassis 14 side) along the Z-axis direction (a plate thickness direction of the light guide plate 16). Each relay wiring member 28 is connected to the power source board PWB to supply driving power to the LEDs 17 therethrough. The board connector 22 is located at an end of the long dimension of the LED board 18. Specifically, each board connector 22 is located at an outer end of the LED board 18 in the long-side direction of the frame 13 and the light guide plate 16 (i.e., an end of the LED board 18 adjacent to the short-side portion of the frame 13). Namely, the board connector 22 of each LED board 18 is located close to a corresponding lower corner portion of the frame 13 and the corresponding lower corner portion of the light guide plate 16 in the vertical direction. The board connector 22 is in a non-luminous portion of the LED board 18. As described above, since the board connector 22 is located at the end of the LED board 18, rays of light emitted from the LEDs 17 are less likely to be blocked by the board connector 22. Two LED boards 18 of the liquid crystal display device 10 are substantially the same in terms of the number of the LEDs 17 (the number of mounted LEDs), the distances between the LEDs 17 (i.e. the mounting intervals or the arrangement pitch), and the position of the board connectors 22. Namely, the two LED boards 18 are the same components. Therefore, the production cost and the parts control cost of the LED boards 18 can be reduced. The LED board 18 is made of metal such as aluminum. Traces (not illustrated) are formed on the surface of the LED board 18 via an insulating layer. The LED board 18 may be made of an insulating material such as ceramic.

As illustrated in FIGS. 3 and 4, the heat dissipation member 19 of each LED unit LU is made of metal having high thermal conductivity, such as aluminum. The heat dissipation member 19 includes an LED mounting portion (a light source mounting portion) 19a and a heat dissipation portion 19b. The LED board 18 is mounted on the LED mounting portion 19a. The heat dissipation portion 19b is in surface-contact with a plate surface of the chassis 14. The LED mounting portion 19a and the heat dissipation portion 19b form an angle therebetween so as to have an L-like shape in a cross-section. The heat dissipation member 19 has a long-side dimension substantially equal to the long-side dimension of the LED board 18. The LED mounting portion 19a of the heat dissipation member 19 has a plate-like shape and is parallel to the plate surface of the LED board 18 and the light entrance surface 16b of the light guide plate 16. A long-side direction, a short-side direction, and a thickness direction of the LED mounting portion 19a correspond to the X-axis direction, the Z-axis direction, and the Y-axis direction, respectively. The LED board 18 is mounted on an inner surface of the LED mounting portion 19a, that is, a plate surface that faces the light guide plate 16. The LED mounting portion 19a has a long-side dimension that is substantially equal to that of the LED board 18, whereas a short-side dimension of the LED mounting portion 19a is larger than that of the LED board 18. Namely, ends of the LED mounting portion 19a in the short-side dimension are farther out than the ends of the LED board 18 in the Z-axis direction. The LED mounting portion 19a includes an outer plate surface opposite from the plate surface on which the LED board 18 is mounted. The outer plate surface of the LED mounting portion 19a is in contact with a side surface of a sub frame 32 mounted to the frame 13. The sub frame 32 will be describes later. The LED mounting portion 19a protrudes from an inner end of the heat dissipation portion 19b, which is an end of the heat dissipation portion 19b closer to the LEDs 17 (the light guide plate 16), in the Z-axis direction (a direction in which the liquid crystal panel 11, the optical member 15, and the light guide plate 16 overlap each other) toward the front side, that is, toward the frame 13.

As illustrated in FIGS. 3 and 4, the heat dissipation portion 19b has a plate-like shape and is parallel to the plate surface of the chassis 14. A long-side direction, a short-side direction, and a thickness direction of the heat dissipation portion 19b correspond to the X-axis direction, the Y-axis direction, and the Z-axis direction, respectively. The heat dissipation portion 19b protrudes from a rear end of the LED mounting portion 19a, which is an end of the LED mounting portion 19a closer to the chassis 14, in the Y-axis direction toward outside, which is a direction opposite from the light guide plate 16. The heat dissipation portion 19b has a long-side dimension substantially equal to the long-side dimension of the LED mounting portion 19a. An entire rear plate surface of the heat dissipation portion 19b, which is a plate surface facing the chassis 14, is in contact with the plate surface of the chassis 14. A front plate surface of the heat dissipation portion 19b is a plate surface opposite from the surface of the heat dissipation portion 19b in contact with the chassis 14. The front surface of the heat dissipation portion 19b is in contact with bottom portions of screw mounting portions (a fixing member mounting portion) 21 of the frame 13 and a bottom portion of the sub frame 32. The sub frame 13, which will be described later, is mounted to the screw mounting portions 21. The heat dissipation portion 19b is sandwiched between the screw mounting portions 21 of the frame 13 and the sub frame 32, and the chassis 14. With this configuration, heat generated from the lighted LEDs 17 as they are turned on is transferred to the chassis 14 and the frame 13 including the screw mounting portions 21 via the LED board 18, the LED mounting portion 19a, and the heat dissipation portion 19b. Therefore, heat is effectively released to the outside of the liquid crystal display device 10 and heat is less likely to stay therein. The heat dissipation portion 19b includes through holes 19b1 in which respective screw members (a fixing member) SM are passed. The heat dissipation portion 19b is fixed to the screw mounting portions 21 with the screw members SM (see FIG. 6 for the through hole 19b1).

Next, configurations of the frame 13 and the chassis 14, which constitute the exterior member and the holding member, will be described. The frame 13 and the chassis 14 are made of metal such as aluminum so as to have high mechanical strength (rigidity) and high thermal conductivity compared to a frame and a chassis that are made of synthetic resin. As illustrated in FIG. 3, the frame 13 and the chassis 14 hold the liquid crystal panel 11, the optical member 15, and the light guide plate 16, which are placed on top of the other, from the front side and the rear side with the LED units LU that are arranged on each end in the short-side direction (the long-side ends) disposed in the space between the frame 13 and the chassis 14.

As illustrated in FIG. 3, the frame 13 has a landscape rectangular shape so as to surround the display area of the display surface 11c of the liquid crystal panel 11. The frame 13 includes a panel holding portion 13a and a side wall 13b. The panel holding portion 13a is parallel to the display surface 11c of the liquid crystal panel 11 and presses the liquid crystal panel 11 from the front. The side wall 13b protrudes from an outer portion of the panel holding portion 13a toward the rear. The panel holding portion 13a and the side wall 13b form an L-like shape in a cross-section. The panel holding portion 13a has a landscape-rectangular and frame-like shape that corresponds to an outer portion of the liquid crystal panel 11 (i.e., the non-display area, the frame-like portion). The panel holding portion 13a presses a substantially entire area of the outer portion of the liquid crystal panel 11 from the front side. The panel holding portion 13a has a width that is large enough to cover not only the outer portion of the liquid crystal panel 11 but also the outer portion of the optical member 15, the outer portion of the light guide plate 16, and the LED units LU from the front side. The outer portions of the optical member 15 and the light guide plate 16 and the LED units LU are located on the outer side with respect to the outer portion of the liquid crystal panel 11. Similar to the display surface 11c of the liquid crystal panel 11, a front exterior surface of the panel holding portion 13a (an opposed surface from the surface facing the liquid crystal panel 11) is seen from the front side of the liquid crystal display device 10. The panel holding portion 13a constitutes a front exterior of the liquid crystal display device 10 together with the display surface 11c of the liquid crystal panel 11. The side wall 13b has a substantially rectangular hollow shape and protrudes from the outer portion (specifically, the outer peripheral edge) of the panel holding portion 13a toward the rear side. The side wall 13b surrounds the liquid crystal panel 11, the optical member 15, the light guide plate 16, and the LED units LU, which are placed in the space between the frame 13 and the chassis 14. The side wall 13b surrounds an entire periphery of the chassis 14 on the rear side. An outer surface of the side wall 13b that extends along a peripheral surface of the liquid crystal display device 10 is seen from the outside of the liquid crystal display device 10. Therefore, the outer surface of the side wall 13b constitutes a top surface, a bottom surface, and side surfaces of the liquid crystal display device 10.

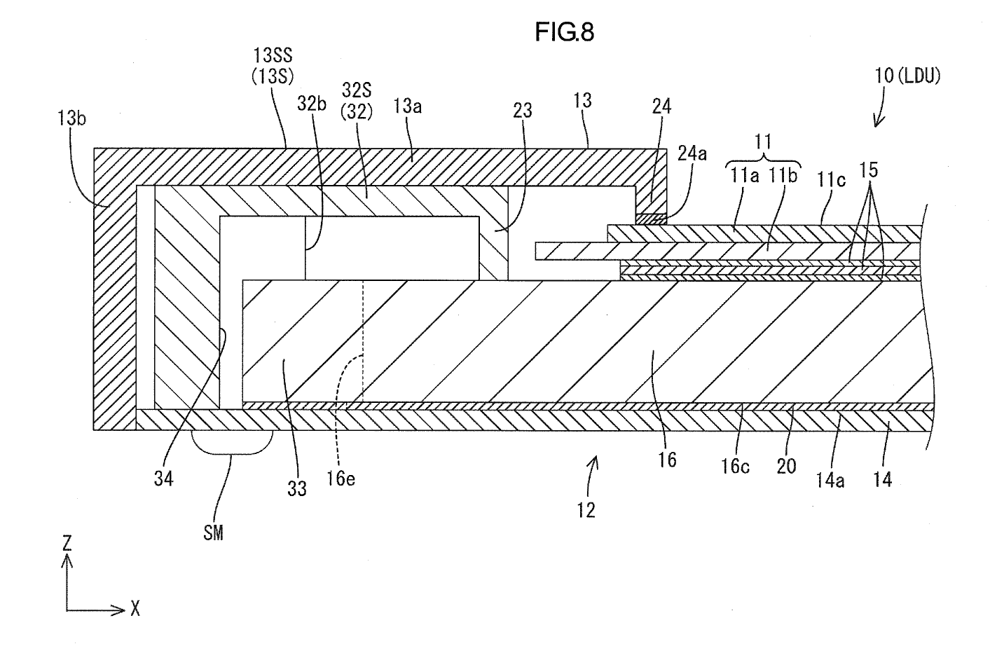

As illustrated in FIGS. 3 and 9, the frame 13 formed in a frame-like shape with the above configuration includes four frame pieces 13S that are assembled together. The frame pieces 13S (long-side portions and short-side portions) each correspond to each side of the frame 13. Specifically, the frame pieces 13S include long-side frame pieces 13SL and short-side frame pieces 13SS that constitute the long-side portions and the short-side portions of the frame 13 (the panel holding portions 13a and the side walls 13b), respectively. Each long-side frame piece 13SL is a block member that extends in the X-axis direction and has an L-like cross section. Each short-side frame piece 13SS is a block member that extends in the Y-axis direction and has an L-like cross section. With this configuration, in the production process, the frame pieces 13S can be formed by extruding metal material, for example. Thus, the production cost can be reduced compared to the frame 13 formed by cutting metal material. The long-side frame pieces 13SL and the short-side frame pieces 13SS that are adjacent to each other form the frame 13 by joining the respective edges thereof in the respective extending directions. The edges of the long-side frame pieces 13SL and the edges of the short-side frame pieces 13SS, which are the joint portions of the frame pieces 13SL and 13SS (joints in the frame 13), are angled against the X-axis and Y-axis directions in a plan view. Specifically, each edge extends along a line connecting an inner edge and an outer edge of each corner of the panel holding portion 13a. The long-side frame pieces 13SL (refer to FIG. 6) cover not only the liquid crystal panel 11, the optical member 15, and the light guide plate 16 but also the LED units LU. The short-side frame pieces 13SS (refer to FIG. 8) do not cover the LED units LU. Therefore, the long-side frame piece 13SL has a relatively larger width than the short-side frame piece 13SS.

As illustrated in FIGS. 4 and 5, the panel holding portion 13a of the frame 13 include a holding protrusion 24 that protrudes from an inner end thereof toward the rear side, namely, toward the liquid crystal panel 11. The holding protrusion 24 includes a shock absorber 24a at its protruded end (see FIGS. 6 and 8 for the shock absorber 24a). The holding protrusion 24 presses the liquid crystal panel 11 from the front side via the shock absorber 24a. Similar to the screw mounting portions 21, the holding protrusion 24 and the shock absorber 24a include separate pieces thereof that extend along the frame pieces 13S of the frame 13. When the frame pieces 13S are assembled together, the holding protrusion 24 and the shock absorber 24a each form a frame-like shape that extends along the inner peripheral end of the panel holding portion 13a.

As illustrated in FIGS. 4 and 9, the panel holding portion 13a includes the screw mounting portions (fixing member mounting portions) 21 formed integrally with other portions thereof. The screw members (fixing members) SM are mounted to the respective screw mounting portions 21. Each screw mounting portion 21 is at a more interior position than the side wall 13b of the panel holding portion 13a (a position away from the side wall 13b toward the light guide plate 16). The screw mounting portion 21 protrudes from an inner surface of the panel holding portion 13a in the Z-axis direction toward the rear side and has a substantially round post-like shape. Multiple screw mounting portions 21 are arranged at intervals along each side of the panel holding portion 13a (in the X-axis direction and the Y-axis direction). As illustrated in FIGS. 4 and 6, each screw mounting portion 21 includes a hole 21a that opens to the rear side for tightening the screw member SM therein. The hole 21a is concentric with the screw mounting portion 21. A diameter of the hole 21a is slightly smaller than that of a shaft of the screw member SM. The screw mounting portion 21 is positioned between the panel holding portion 13a of the frame 13 and the chassis 14 in the Z-axis direction.

As illustrated in FIGS. 4 and 9, the sub frame 32 (positioning members) is attached to the panel holding portion 13a of the frame 13 such that the sub frame 32 is fitted in the screw mounting portions 21. The sub frame 32 is made of synthetic resin and an overall shape of the sub frame 32 is a landscape frame-like shape. The sub frame 32 is in contact with the inner surface (the surface facing the rear side) of the panel holding portion 13a when the sub frame 32 is fitted in the screw mounting portions 21. Similar to the frame 13, the sub frame 32 includes four sub frame pieces 32S. The sub frame pieces 32S correspond to side portions of the sub frame 32 (long-side portions and short-side portions), respectively. Each sub frame piece 32S has an elongated block-like shape that extends along the corresponding side portion of sub frame 32. As illustrated in FIGS. 6 and 9, the sub frame piece 32S includes insertion holes 32a at portions corresponding to the screw mounting portions 21 in a plan view. The screw mounting portions 21 are inserted in the respective insertion holes 32a of the sub frame pieces 32S. The insertion holes 32a are arranged at intervals along an extending direction of each sub frame piece 32S of the sub frame 32. As illustrated in FIGS. 4 and 5, a width of the sub frame 32 having a frame-like shape is smaller than that of the frame 13 over its entire length. The sub frame 32 has an outer end and an inner end. The outer end is inward with respect to the side wall 13b and the inner end that is outward with respect to the panel holding protrusion 24. The sub frame 32 includes inner peripheral surfaces that are opposing surfaces opposite substantially entire peripheral surfaces of the light guide plate 16. Rays of light leaking from the peripheral surfaces of the light guide plate 16 are absorbed or blocked by the inner peripheral surfaces of the sub frame 32. With this configuration, the rays of light are less likely to leak to the space outside the sub frame 32.

As illustrated in FIGS. 4 and 5, the sub frame 32 includes light guide plate holding portions 23 as a part thereof. The light guide plate holding portions 23 hold the light guide plate 16 from the front side (the display surface 11c side). Each light guide plate holding portion 23 has a substantially L-like shape in a cross section. Specifically, the light guide plate holding portion 23 protrudes from an inner edge of the sub frame 32 toward the inner side, that is, toward the light guide plate 16, and protrudes at an angle in the Z-axis direction (the protruding direction of the screw mounting portion 21) toward the rear side (the light guide plate 16). The light guide plate holding portions 23 extend along the respective sub frame piece 32S and form a substantially frame-like shape as a whole similar to the sub frame 32. Distal ends of the light guide plate holding portions 23 are in contact with the outer portion of the light guide plate 16 outer than the liquid crystal panel 11. Specifically, the distal ends of the light guide plate holding portions 23 are in contact with a front surface of the outer portion of the light guide plate 16, that is, in contact with the light exit surface 16a. Therefore, the light guide plate holding portions 23 are configured to sandwich the light guide plate 16 between the light guide plate holding portions 23 and the chassis 14, which will be described later, so as to support the light guide plate 16 from the front side (the display surface 11c side). Namely, the light guide plate holding portions 23 have a light guide plate support function. As illustrated in FIG. 4, the light guide plate holding portion 23 on the lower side in the vertical direction, that is, closer to the LED units LU, supports the long end of the light guide plate 16 having the light entrance surface 16b. With this configuration, the positional relationship between the LEDs 17 and the light entrance surface 16b in the Z-axis direction can be stably maintained. The light guide plate holding portion 23 is arranged between the liquid crystal panel 11 and the LEDs 17. Specifically, the light guide plate holding portion 23 shuts the space between the LEDs 17 and the peripheral surfaces of the liquid crystal panel 11 and the optical member 15 on the LEDs 17 side. Therefore, light from the LEDs 17 is less likely to directly enter the peripheral surfaces of the liquid crystal panel 11 and the optical member 15 without passing through the light guide plate 16. In other words, the light guide plate holding portions 23 have function as a light blocking portion that blocks light. Three light guide plate holding portions 23 except for the light guide plate holding portion 23 closer to the LED units LU are located between the corresponding peripheral surfaces of the light guide plate 16 excluding the light entrance surface 16b and the corresponding peripheral surfaces of each of the liquid crystal panel 11 and the optical member 15. Therefore, rays of light leaking from the peripheral surfaces of the light guide plate 16 are blocked by the light guide plate holding portions 23. With this configuration, the rays of light are less likely to enter the liquid crystal panel 11 and the optical member 15 through the peripheral surfaces of the liquid crystal panel 11 and the optical member 15.

As illustrated in FIGS. 3 and 4, the chassis 14 has a substantially tray-like shape having a horizontally elongated shape as a whole and covers the entire areas of the light guide plate 16 and the LED units LU from the rear side. The chassis 14 has a rear surface (the surface opposite to the surface facing the light guide plate 16 and the LED unit LU) that is seen from the outside of the liquid crystal display device 10 and provides a rear surface of the liquid crystal display device 10. The chassis 14 includes a light guide plate receiving portion 14a and a holding portion 14b. The light guide plate receiving portion 14a has a horizontally elongated rectangular shape similar to the light guide plate 16. The holding portion 14b protrudes from a long-side portion of the light guide plate receiving portion 14a on the lower side in the vertical direction toward the rear side in a step-like shape. The LED units LU are arranged in the light guide plate receiving portion 14a. The light guide plate 16 is arranged such that a middle section thereof overlaps the light guide plate receiving portion 14a in a plan view and such that the end portion of the light guide plate 16 having the light entrance surface 16b protrudes outward over the light guide plate receiving portion 14a and overlaps the holding portion 14b in a plan view.

As illustrated in FIGS. 3 and 5, the light guide plate receiving portion 14a has a flat plate shape to receive a portion of the light guide plate 16 from the rear side, except the long-side portion of the light guide plate 16 having the light entrance surface 16b. The holding portion 14b is recessed from the long-side portion of the light guide plate receiving portion 14a toward the rear side to provide a space for holding the LED units LU therein. As illustrated in FIG. 4, the holding portion 14b includes a bottom plate 14b1, which extends parallel to the light guide plate receiving portion 14a, and sidewalls 14b2a and 14b3, which extend upward from respective ends of the bottom plate 14b1 toward the front side. An inner sidewall 14b2 of the sidewalls 14b2 and 14b3 continues to the light guide plate receiving portion 14a. On the bottom plate 14b1, the heat dissipation portion 19b of the heat dissipation member 19, which is included in the LED unit LU, is disposed such that a surface of the heat dissipation portion 19b is in contact with the inner surface of the bottom plate 14b1. The screw members (fixing members) SM are mounted to the bottom plate 14b1 from the outside to fix the frame 13 and the chassis 14 together.

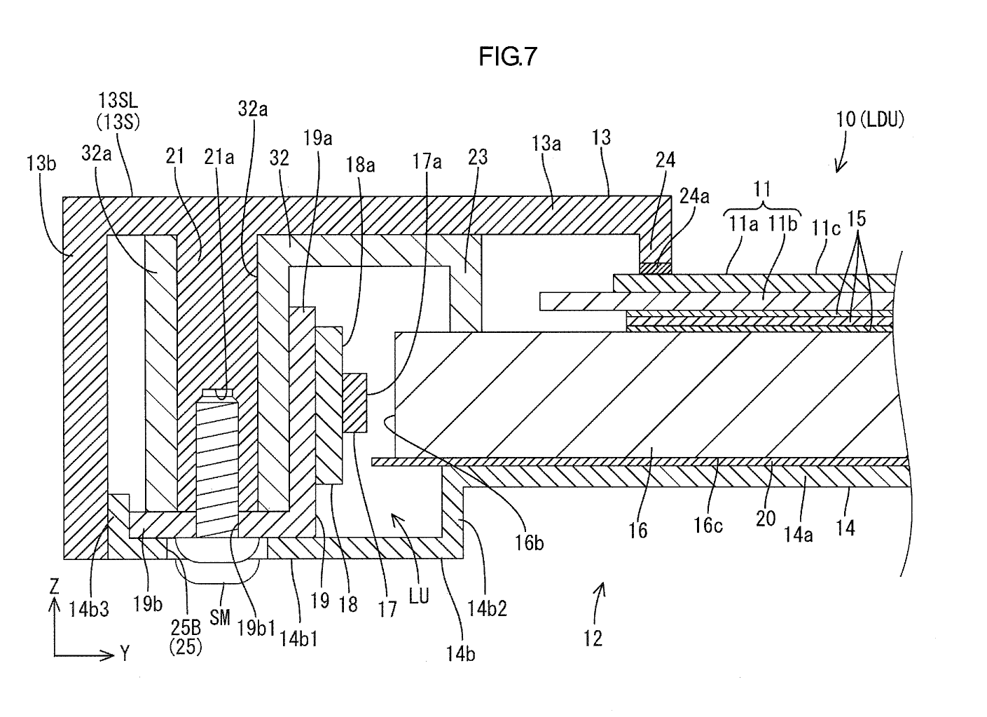

As illustrated in FIGS. 3, 6, and 7, the light guide plate receiving portion 14a and the bottom plate 14b1 of the holding portion 14b include multiple screw holes 25 in which the screw members SM are inserted. The screw holes 25 of light guide plate receiving portion 14a and the screw holes 25 of the bottom plate 14b1 of the holding portion 14b are arranged corresponding to the screw mounting portions 21 of the frame 13 in a plan view. Each screw hole 25 is communicated with the hole 21a of the corresponding screw mounting portion 21. With this configuration, the screw member SM is passed through the screw hole 25 in the Z-axis direction (the overlapping direction of the liquid crystal panel 11, the optical member 15, and the light guide plate 16) from the rear side of the chassis 14 (the side opposite to the display surface 11c side). The screw member SM is inserted in the hole 21a and fastened to the screw mounting portion 21 with the bottom plate 14b1 disposed therebetween. When the screw member SM is fastened, threads of the shaft of the screw member SM form thread grooves in the hole 21a. The screw holes 25 in the bottom plate 14b1 of the holding portion 14b include a joint screw hole 25A and a heat dissipation member screw hole 25B. As illustrated in FIG. 6, the joint screw hole 25A has a size through which only the shaft of the screw member SM passes. As illustrated in FIG. 7, the heat dissipation member screw hole 25B has a size through which both of a head and the shaft of the screw member SM pass. The screw member SM is passed through the joint screw hole 25A to fasten the heat dissipation portion 19b and the bottom plate 14b1 together to the screw mounting portion 21. The screw member SM is passed through the heat dissipation member screw hole 25B to fasten only the heat dissipation portion 19b to the screw mounting portion 21.

As illustrated in FIG. 9, the backlight unit 12 according to this embodiment includes a positioning structure for positioning the light guide plate 16 having the configurations described earlier. The positioning structure includes mating portions 33 of the light guide plate 16 and positioning portions 34 of the sub frame 32. The mating portions 33 are fitted in the respective positioning portions 34, and thus the light guide plate 16 is positioned with respect to a plate surface direction of the light guide plate 16. Each mating portion 33 is located at a portion of the light guide plate 16 close to LEDs 17 in the Y-axis direction (an arrangement direction of the LEDs 17 and the light guide plate 16). Each positioning portion 34 is located at a portion of the sub frame 32 close to LEDs 17 in the Y-axis direction.

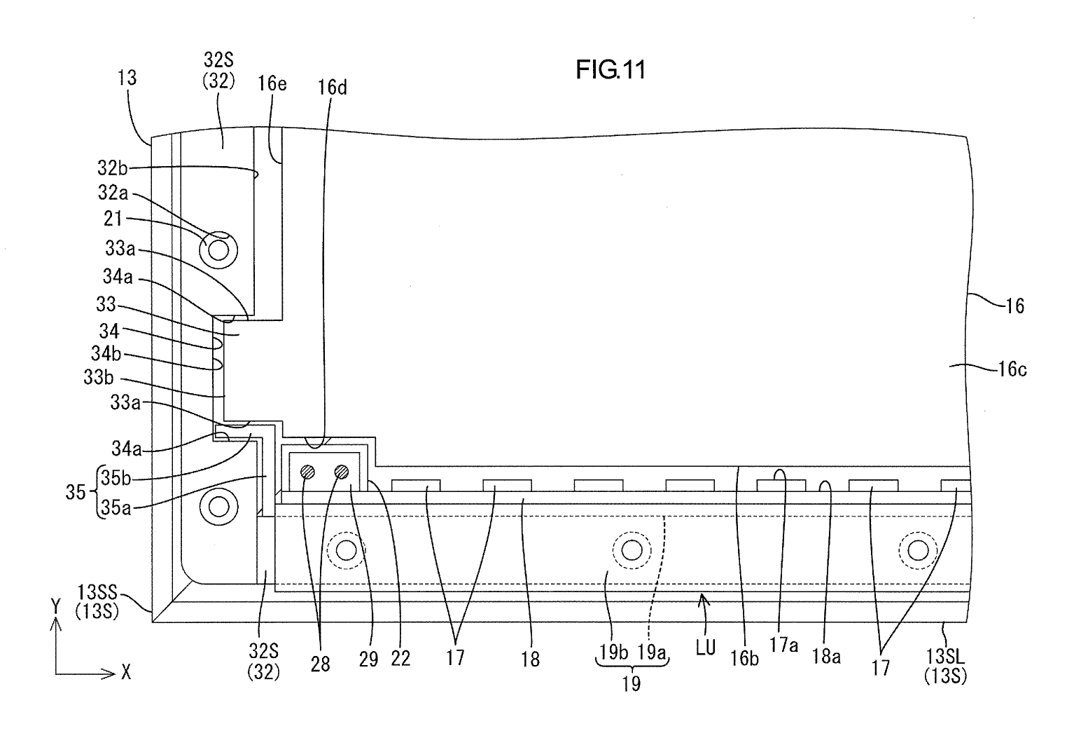

As illustrated in FIGS. 5 and 9, the mating portions 33 protrude from peripheral surfaces (light source non-opposing surfaces) 16e at the short sides of the light guide plate 16 adjacent to the light entrance surface 16b, respectively. As illustrated in FIGS. 10 and 11, the mating portion 33 has a rectangular shape that extends in the vertical direction in a plan view. The mating portion 33 includes two first side-surfaces 33a and a second side-surface 33b. The first side-surfaces 33a are parallel to the X-axis direction and face away from each other. The second side-surface 33b is parallel to the Y-axis direction. The first side-surfaces 33a are on short sides of the mating portion 33 and the second side-surface 33b is on a long side of the mating portion 33. The mating portion 33 is located at one of end portions of the short-side peripheral surface 16e closer to the light entrance surface 16b. The cutout (corner portions at respective ends of a long-side portion that includes the light entrance surface 16b) 16d is adjacent to the corresponding mating portion 33.

As illustrated in FIGS. 5 and 9, the positioning portions 34 are formed in inner peripheral surfaces 32b of the sub frame 32 on the short sides. The inner peripheral surfaces 32b are opposite the respective short-side peripheral surfaces 16e of the light guide plate 16. The positioning portions 34 are recesses for receiving the mating portions 33. As illustrated in FIGS. 10 and 11, each positioning portion 34 has a recessed shape that corresponds to the outline of the mating portion 33 and extends in the vertical direction in a plan view. The positioning portion 34 includes two first side-surfaces 34a and a second side-surface 34b. The first side-surfaces 34a are opposite to each other and parallel to the X-axis direction. The second side-surface 34b is parallel to the Y-axis direction and faces a lateral outer side. The first side-surfaces 34a are on short sides of the positioning portion 34, respectively, and the second side-surface 34b is on a long side of the positioning portion 34. As illustrated in FIG. 11, when the mating portion 33 of the light guide plate 16 is fitted in the positioning portion 34 of the sub frame 32, the first side-surfaces 33a of the mating portion 33 are opposed to the respective first side-surfaces 34a of the positioning portion 34. Thus, the light guide plate 16 is positioned with respect to the sub frame 32 (i.e., the frame 13) in the Y-axis direction. Namely, the position of the light guide plate 16 is fixed in an arrangement direction of the LEDs 17 and the light guide plate 16. A clearance is provided between the second side-surface 34b of the positioning portion 34 and the second side-surface 33b of the mating portion 34 to allow the size increase of the light guide plate 16 in the long-side direction thereof (the X-axis direction) due to its thermal expansion.

As illustrated in FIGS. 10 to 12, the heat dissipation members 19 include restriction portions 35 for restricting a distance between the LEDs 17 and the light entrance surface 16b of the light guide plate 16 using the positioning structure described earlier. The LED boards 18 are mounted on the heat dissipation members 19. The restriction portion 35 projects from the LED mounting portion 19a of the heat dissipation member 19 at an end of a longitudinal dimension of the LED mounting portion 19a (i.e., the X-axis direction). A distal end of the restriction portion 35 is sandwiched between one of the first side-surfaces 33a of the mating portion 33 (an opposing surface) and one of the first side-surfaces 34a of the positioning portion 34 (an opposing surface). The first side-surfaces 33a, 34a are opposite to each other in the Y-axis direction. The restriction portion 35 is in contact with the first side-surface 33a of the mating portion 33 and the first side-surface 34a of the positioning portion 34. With this configuration, the distance between the LEDs 17 and the light entrance surface 16b of the light guide plate 16 in the Y-axis direction is controlled by the restriction portion 35. In this embodiment, the LEDs 17 are mounted on the respective LED boards 18. The LED boards 18 are mounted on the respective heat dissipation members 19. The heat dissipation members 19 are mounted on the sub frame 32. In such configurations, errors in positions of the components tend to become larger and thus the positions of the LEDs 17 are more likely to vary in the Y-axis direction with respect to the light entrance surfaces 16b of the light guide plates 16. As described earlier, the restriction portions 35 of the heat dissipation members 19 directly contact the respective mating portions 33 and the respective positioning portions 34 that are the positioning structure for the light guide plate 16. With this configuration, the LEDs 17 are positioned with high accuracy with respect to the light entrance surface 16b of the light guide plate 16 in the Y-axis direction. With this configuration, high light entrance efficiency of light that exits from the LEDs 17 and enters the light entrance surface 16b of the light guide plate 16 can be achieved and maintained, and accordingly brightness of exiting light through the light exit surface 16a is improved. Therefore, uneven brightness is less likely to occur in the exiting light. Specific configurations of the restriction portion 35 will be described.

As illustrated in FIGS. 10 to 12, the restriction portion 35 has a substantially L-shape in a plan view. The restriction portion 35 includes a lateral portion 35a and a restriction piece 35b. The lateral portion 35a projects from the end of the long dimension of the LED mounting portion 19a and extends in the Y-axis direction toward the light guide plate 16. The restriction piece 35b projects at an angle from a distal end of the lateral portion 35a and extends outward along the X-axis direction. More specifically, the lateral portion 35a has substantially the same height (the dimension in the Z-axis direction) as the LED mounting portion 19a. The lateral portion 35a protrudes from the end of the long dimension of the LED mounting portion 19a closer to the board connector 22 and extends inward along the Y-axis direction. The lateral portion 35a is beside the LED board 18 and the board connector 22. In other words, the LED board 18 and the board connector 22 are arranged such that the lateral portion 35a overlaps the LED board 18 and the board connector 22 from an outer lateral side. Therefore, the LED board 18 and the board connector 22 are not seen from the outer lateral side and thus the LED board 18 and the board connector 22 are protected by the lateral portion 35a. The lateral portion 35a includes an inner plate surface and an outer plate surface. The inner plate surface is opposite a peripheral surface of the LED board 18 and a side surface of the board connector 22. The outer plate surface of the lateral portion 35a is opposite the inner peripheral surface 32b of the sub frame piece 32S on the short side. The distal end of the lateral portion 35a is located farther away from a projecting base than the board connector 22 but closer to the projecting base than the positioning portion 34. The restriction piece 35b continues from the distal end of the lateral portion 35a.

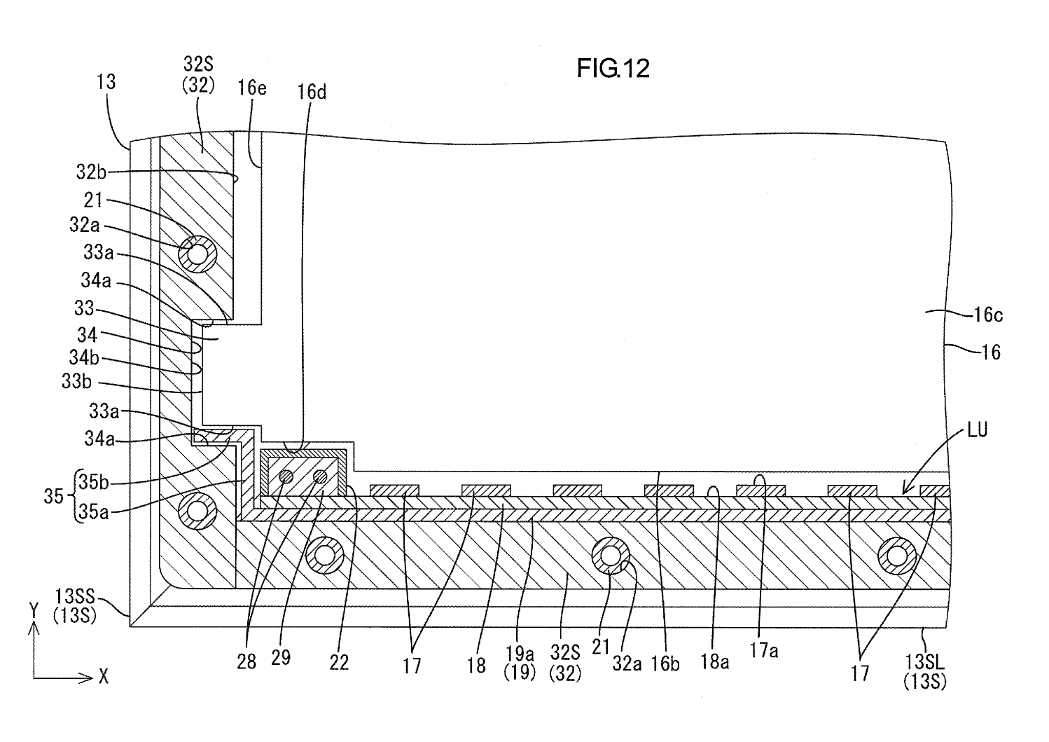

As illustrated in FIGS. 10 to 12, the restriction piece 35b has a plate-like shape that projects at a substantially right angle from the distal end of the lateral portion 35a and extends outward along the X-axis direction. The restriction piece 35b is sandwiched between one of the first side-surfaces 33a close to the light entrance surface 16b or the LEDs 17 and one of the first side-surfaces 34a opposite the first side surface 33a. The first side-surface 33a of the mating portion 33 is the surface close to a base side in the protrusion direction of the lateral portion 35a. The first side-surface 34a of the positioning portion 34 is the surface close to the light entrance surface 16b and the LEDs 17. The restriction piece 35b is in contact with the first side-surfaces 33a and 34a. The restriction piece 35b includes plate surfaces parallel to the first side-surfaces 33a and 34a (i.e., the X-axis direction and the Z-axis direction). One of the plate surfaces of the restriction piece 35b on the upper side in FIGS. 11 and 12 is opposite and in contact with the first side-surface 34a of the positioning portion 34. The other plate surface of the restriction piece 35b on the lower side in FIGS. 11 and 12 is opposite and in contact with the first side-surface 33a of the mating portion 33. In other words, in the positioning portion 34 of the sub frame 32 having a recess, the restriction piece 35b of the heat dissipation member 19 is fitted in addition to the mating portion 33 of the light guide plate 16, which is a protrusion. With the positioning portion 34, the positions of the mating portion 33 and the restriction piece 35b in the Y-axis direction are fixed. In this configuration, because the positioning portions 34 have positioning functions for the light guide plate 16 and the heat dissipation members 19, the distance between the light guide plate 16 and the LEDs 17 in the Y-axis direction is controlled with high accuracy.

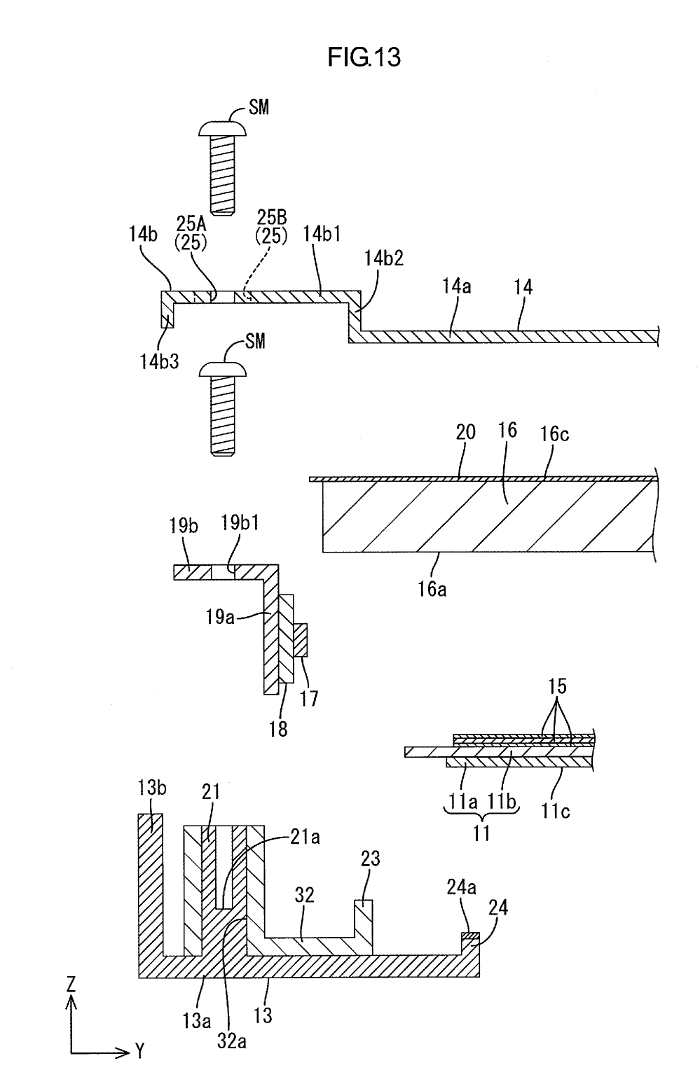

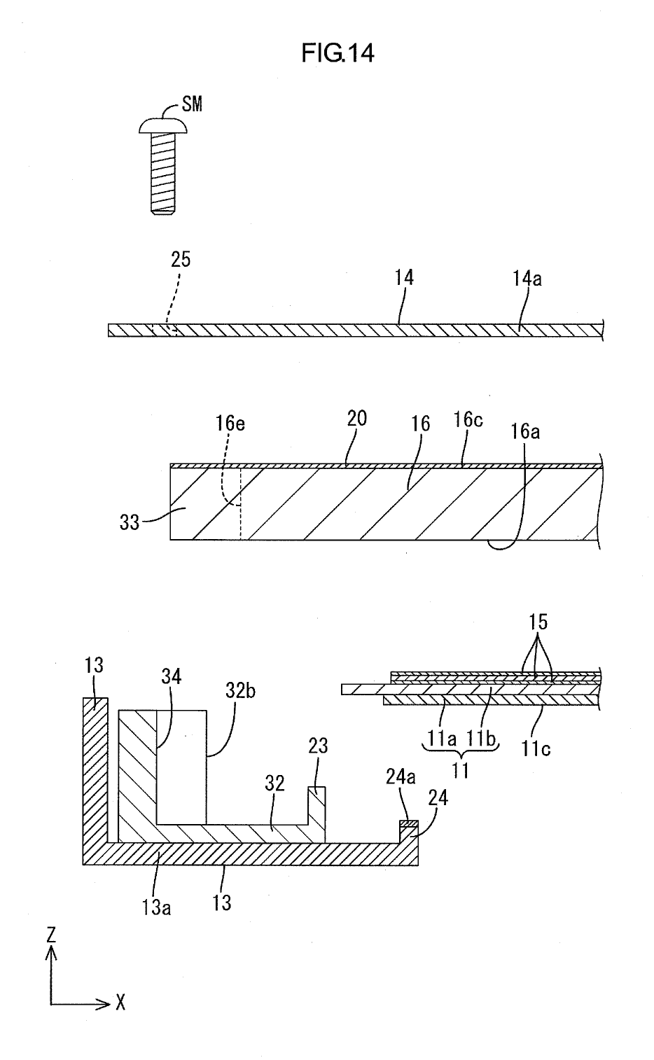

The present embodiment has the above-described configurations, and operations thereof will be described. The components (e.g. the frame 13, the chassis 14, the liquid crystal panel 11, the optical member 15, the light guide plate 16, and the LED units LU) which are separately produced are mounted into the liquid crystal display device 10. In the assembly, all of the components orientated as in FIGS. 6 to 8 are turned upside down in the Z-axis direction. As illustrated in FIGS. 13 and 14, the frame 13 of the components is placed on a workbench, which is not illustrated, with the rear surface of the frame 13 facing the upside in the vertical direction. The frame 13 is formed into a frame shape in advance by jointing the four frame pieces 13S. The sub frame 32 is attached to the frame 13.

As illustrated in FIGS. 13 and 14, the liquid crystal panel 11 is then mounted to the frame 13 and the sub frame 32 in the above state. During the mounting operation, the CF substrate 11a is arranged on the lower side in the vertical direction and the array substrate 11b is arranged on the upper side in the vertical direction. The liquid crystal panel 11 is placed on the shock absorber 24a attached on the holding protrusion 24 so that shocks are absorbed by the shock absorber 24a. Then, the optical member 15 is sequentially placed on the rear surface of the liquid crystal panel 11. [The light guide plate 16 is directly placed on the rear surface of the optical member 15 that is disposed on the most rear side. As illustrated in FIG. 14, the mating portion 33 that protrudes from the short-side peripheral surface 16e of the light guide plate 16 is fitted in the positioning portion 34 formed in the inner peripheral surface 32b of the sub frame 32 on the short side (see FIGS. 10 to 12). A clearance by a thickness of the restriction portion 35 is provided between the mating portion 33 and the positioning portion 34. Therefore, the fitting step can be easily performed and thus the workability is improved. When the mating portion 33 and the positioning portion 34 are fitted together, the first side-surfaces 33a of the mating portion 33 are opposite the respective first side-surfaces 34a of the positioning portion 34. The second side-surface 33b of the mating portion 33 is opposite the second side-surface 34b of the positioning portion 34. With this configuration, the light guide plate 16 is positioned in the plate surface direction of the light guide plate 16 (the X-axis direction and the Y-axis direction). The end portions of the light guide plate 16 that protrude outward over the respective ends of the liquid crystal panel 11 are supported by the frame-like light guide plate holding portion 23 of the sub frame 32 from the front side, that is, from the lower side in the vertical direction during the mounting step. After the light guide plate 16 is arranged, the light guide reflection sheet 20 is directly placed onto the surface 16c that is opposite to the light exit surface 16a of the light guide plate 16.

Next, as illustrated in FIG. 13, the LED unit LU including the LED 17, the LED board 18, and the heat dissipation member 19 that are mounted together in advance is mounted to the frame 13 and the sub frame 32. The LED unit LU is attached such that the LEDs 17 face the middle (inward) of the frame 13 and such that the heat dissipation member 19 corresponds to the long-side portion of the sub frame 32. In the mounting step of the LED units LU, the restriction portion 35 of the heat dissipation member 19 is arranged so as to be sandwiched between the first side-surface 33a of the mating portion 33 and the first side-surface 34a of the positioning portion 34 that are closer to the light entrance surface 16b or the LEDs 17 (see FIGS. 10 to 12). More specifically, the restriction piece 35b at the distal end of the lateral portion 35a is in a gap between the first side-surface 33a of the mating portion 33 and the first side-surface 34a of the positioning portion 34 closer to the light entrance surface 16b or the LEDs 17. Furthermore, the restriction piece 35b is in contact with the first side-surfaces 33a and 34a that are opposite to each other. With this configuration, the light guide plate 16 and the LEDs 17 are positioned with respect to the sub frame 32 in the Y-axis direction. With the restriction piece 35b, the mating portion 33 fitted in the positioning portion 34 is positioned away from the LEDs 17 in the Y-axis direction within the positioning portion 34. Thus, the light guide plate 16 is positioned. The restriction piece 35b is sandwiched between the mating portion 33 and the positioning portion 34. With this configuration, the distance between the LEDs 17 and the light entrance surface 16b of the light guide plate 16 is controlled. Therefore, the positional relation between the LEDs 17 and the light entrance surface 16b in the Y-axis direction is fixed with high accuracy. The board connectors 22 of the LED boards 18 are arranged in the respective cutouts 16d of the light guide plate 16. In the fixing step of the LED units LU to the frame 13 and the sub frame 32, the heat dissipation portion 19b is arranged such that through holes 19b1 of the heat dissipation portion 19b are communicated with the respective holes 21a of the screw mounting portions 21. The screw members SM are inserted in the holes 19b1 and 21a for fastening. The relay connector 29 that is arranged at the ends of the relay wiring member 28 is connected to the board connector 22 in advance (see FIG. 11). The mounting steps of the light guide plate 16 and the LED units LU can be altered as appropriate. For example, the LED units LU may be mounted first and the light guide plate 16 may be mounted.

After the above-described mounting steps of the liquid crystal panel 11, the optical member 15, the light guide plate 16, the LED unit LU, and the relay wiring member 28 to the frame 13 and the sub frame 32, the mounting step of the chassis 14 is performed. As illustrated in FIGS. 13 and 14, the chassis 14 is mounted to the frame 13 and the sub frame 32 with the front surface facing the lower side in the vertical direction. The sidewall 14b3 of each long side of the chassis 14 is inserted in the space between the corresponding long-side sidewall 13b of the frame 13 and long-side portion of the sub frame 32. Accordingly, the chassis 14 is positioned with respect to the frame 13 in the Y-axis direction. In the mounting step, the head portions of the screw members SM mounted to the heat dissipation members 19 and the screw mounting portions 21 in advance are passed through the heat dissipation member screw holes 25B of the holding portion 14b of the chassis 14 (see FIG. 7). Then, the light guide plate receiving portion 14a of the chassis 14 comes into contact with the light guide plate 16 (or the light guide reflection sheet 20), and the bottom plate 14b1 of the holding portion 14b comes into contact with the heat dissipation portion 19b of each heat dissipation member 19. Subsequently, the screw members SM are inserted into the joint screw holes 25A of the bottom plate 14b1 of the holding portion 14b from the rear side. The screw members SM are then fastened in the holes 21a of the respective screw mounting portions 21. The LED units LU and the chassis 14 are fixed to the screw mounting portions 21 by the screw members SM (see FIG. 6). In this configuration, the screw members SM are arranged on the rear side of the chassis 14 that provides the rear exterior of the liquid crystal display device 10. Therefore, the screw members SM are less likely to be recognized from the front side, that is, the user of the liquid crystal display device 10 is less likely to see the screw members SM directly. The liquid crystal display device 10 can have an improved design with a simplified appearance.

The mounting operation of the liquid crystal display unit LDU is completed as above. Then, the stand attachments STA and the boards PWB, MB, and CTB are mounted to the rear side of the liquid crystal display unit LDU. To the board connector PWBC included in the power source board PWB, a relay member connector (not illustrated) connected at an end of the relay wiring member 28 that is led out of the chassis 14 is fitted. This allows the drive power from the power source board PWB located outside the chassis 14 to be sent to the LEDs 17 on the LED board 18 via the relay wiring member 28. Then, the stand ST and the cover CV are attached to the liquid crystal display unit LDU. Thus, the liquid crystal display device 10 and the television device TV are produced. The appearance of the liquid crystal display device 10 produced as above is provided by the frame 13 that holds the liquid crystal panel 11 from the display surface 11c side and the chassis 14 that constitutes the backlight unit 12. Further, the liquid crystal panel 11 and the optical member 15 are placed on top of one another directly. In some conventional liquid crystal display devices, a cabinet that is made of synthetic resin may be provided separately from the frame 13 and the chassis 14 or a panel receiving member may be arranged between the liquid crystal panel 11 and the optical member 15 such that the liquid crystal panel 11 and the optical member 15 are not in contact with each other. Compared to such a configuration, the production cost can be reduced because the numbers of components and assembly steps are reduced. Furthermore, the thickness and weight of the liquid crystal display device 10 can be reduced.

When the liquid crystal display device 10 produced as above is turned on and power is supplied from the power source board PWB, signals are sent from the control board CTB to the liquid crystal panel 11 via the flexible circuit board, which is not illustrated, and operation of the liquid crystal panel 11 is controlled. Furthermore, the power is supplied to the LEDs 17 via the relay wiring members 28, and the LEDs 17 are driven. Light from each LED 17 enters the light guide plate 16 and travels through the optical member 15. The light is converted into a planar light while passing through the optical member 15 and travels toward the liquid crystal panel 11. The liquid crystal panel 11 displays images on the display surface 11c using the planer light. Operations of the backlight unit 12 will be described in detail. As illustrated in FIG. 6, when the LED 17 is turned on, light emitted from the LED 17 enters the light guide plate 16 through the light entrance surface 16b. Light entrance efficiency of light that enters the light entrance surface 16b varies according to the distance between the LEDs 17 and the light entrance surface 16b. As the distance between the LEDs 17 and the light entrance surface 16b increases, the efficiency of the entering light decreases. As the distance between the LEDs 17 and the light entrance surface 16b decreases, the efficiency of the entering light increases. As illustrated in FIGS. 11 and 12, the distance between the LEDs 17 and the light entrance surface 16b is controlled by the restriction portions 35, as described earlier. Namely, the distance between the LEDs 17 and the light entrance surface 16b is less likely to vary. With this configuration, light entrance efficiency of light that enters the light entrance surface 16b can be achieved and maintained. As illustrated in FIG. 6, the light entered the light guide plate 16 through the light entrance surface 16b may be totally reflected at an interface of the light guide plate 16 with an outer air layer, or reflected by the light guide reflection sheet 20. The light thus travels throughout the light guide plate 16. The light is reflected and scattered by reflection portions or scattering portions, which are not illustrated, of the light guide plate 16 and exits the light guide plate 16 through the light exit surface 16a toward the optical member 15. With this configuration, high brightness of the exiting light is achieved while uneven brightness is less likely to occur within the light entrance surface 16b because the brightness of the exiting light is defined based on the light entrance efficiency of the light that enters the light entrance surface 16b.

As described earlier, the liquid crystal display device (a lighting device) 10 includes the LEDs (a light source) 17, the light guide plate 16, the mating portions 33, the positioning portions 34, the heat dissipation members 19 (a light source mounting member) on which the LEDs 17 are arranged in a line, and the restriction portions 35. The light guide plate 16 includes the peripheral surface and the plate surface. The peripheral surface faces the LEDs 17 and configured as the light entrance surface 16b through which light enters the light guide plate 16. The plate surface is configured as the light exit surface 16a through which light exits. The mating portions 33 protrude from portions of the peripheral surfaces 16e of the light guide plate 16 adjacent to the light entrance surface 16b, respectively, or the mating portions 33 are recesses formed in portions of the peripheral surfaces 16e of the light guide plate 16, respectively. The positioning portion 34 is for positioning the light guide plate 16 with respect to the arrangement direction of the LEDs 17 and the light guide plate 16 with the positioning portion 34 and the mating portion 33 fitted together. The restriction portion 35 is included in the heat dissipation member 19 and sandwiched between the first surface 34a of the positioning portion 34 and the first surface 33a of the mating portion 33, which are the opposing surfaces opposite to each other in the arrangement direction. The restriction portion 35 is configured to restrict the distance between the LEDs 17 and the light entrance surface 16a.

In this configuration, light from the LEDs 17 enters the light entrance surface 16b of the light guide plate 16, travels inside the light guide plate 16, and exits through the light exit surface 16a. The mating portions 33 are arranged in the areas of the peripheral surfaces 16e of the light guide plate 16 that are adjacent to the light entrance surface 16b of the light guide plate 16. The mating portions 33 are fitted in the positioning portions 34 and thus the light guide plate 16 is positioned in the arrangement direction of the LEDs 17 and the light guide plate 16. The restriction portion 35 of each heat dissipation member 19 is sandwiched between the first side-surface 33a of the corresponding mating portion 33 and the first side-surface 34a of the corresponding positioning portion, which are the opposing surfaces opposite to each other in the arrangement direction. With this configuration, the distance between the LEDs 17, which are mounted on the heat dissipation members 19 including the restriction portions 35, and the light entrance surface 16b of the light guide plate 16 is controlled. Namely, the position of the LEDs 17 with respect to the light entrance surface 16b of the light guide plate 16 is fixed by the positioning portions 34 and the mating portions 33, which are portions for positioning the light guide plate 16 in the arrangement direction. Therefore, the positional relation between the LEDs 17 and the light entrance surface 16b is fixed with high accuracy. With this configuration, light entrance efficiency of light that exits the LEDs 17 and enters the light entrance surface 16b is improved and maintained. Thus, brightness of light that exits through the light exit surface 16a is improved and uneven brightness is less likely to occur in the exiting light.

The mating portions 33 protrude from the peripheral surfaces 16e of the light guide plate 16 adjacent to the light entrance surface 16b. Each positioning portion 34 has a recessed shape corresponding to the outline of the mating portion 33. In this configuration, the mating portion 33 protrudes from the peripheral surface 16e adjacent to the light entrance surface 16b of the light guide plate 16. The positioning portion 34 has a recessed shape corresponding to the outline of the mating portion 33. The restriction portion 35 is sandwiched between the first side-surface 33a of the mating portion 33 and the first side-surface 34a of the positioning portion 34, which are opposing surfaces facing to each other in the arrangement direction. Namely, the restriction portion 35 is located outward with respect to the peripheral surface 16e that is adjacent to the light entrance surface 16b of the light guide plate 16. In comparison to a configuration in which the mating portion is a recess in the peripheral surface 16e, the restriction portion 35 of this embodiment is less likely to block light traveling inside the light guide plate 16. Therefore, light use efficiency is improved. This configuration is preferable for increasing the brightness, and more preferable for reducing uneven brightness.

Each of the positioning portion 34 and the mating portion 33 includes one of the opposing surfaces that is closer to the LEDs 17 and the other opposing surface away from the LEDs 17 with respect to the arrangement direction. The restriction portion 35 is sandwiched between the first side-surfaces 33a, 34a closer to the LEDs 17, that is, the opposing surfaces of the mating portion 33 and the positioning portion 34 closer to the LEDs 17. In comparison to a configuration in which a restriction portion is sandwiched between the first side-surfaces 33a, 34a away from the LEDs 17, which are the opposing surfaces of the positioning portion 34 and the mating portion 33 away from the LEDs 17, the length of the restriction portion 35 from the heat dissipation member 19 can be reduced. Therefore, dimensional errors of the restriction portion 35 can be reduced and the distance between the LEDs 17 and the light entrance surface 16b is properly controlled by the restriction portion 35.

The mating portions 33 are located closer to the LEDs 17 side of the respective peripheral surfaces 16e that are adjacent to the light entrance surface 16b of the light guide plate 16. If the light guide plate 16 thermally expands or contracts, the light guide plate 16 expands or contracts with the positioning portions 34 and the mating portions 33 as an origin. The mating portions 33 are located closer to the LEDs 17 side of the peripheral surfaces 16e of the light guide plate 16 that are adjacent to the light entrance surface 16b of the light guide plate 16. With this configuration, a variation in position of the light entrance surface 16b due to thermal expansion or contraction can be reduced. Accordingly, a variation in light entrance efficiency of light exiting the LEDs 17 and entering the light entrance surface 16b of the light guide plate 16 can be reduced. This configuration is more preferable for reducing uneven brightness. Furthermore, the lengths of the restriction portions 35 from the heat dissipation members 19 can be reduced. Therefore, errors in positions of the restriction portions 35 can be reduced and thus the distance between the LEDs 17 and the light entrance surface 16b is properly controlled by the restriction portions 35.

The backlight unit 12 includes the sub frame (a positioning member) 32 including the inner peripheral surfaces 32b. The inner peripheral surfaces 32b are the opposing surfaces opposite the respective peripheral surfaces 16e of the light guide plate 16 that are adjacent to the light entrance surface 16b of the light guide plate 16. The positioning portions 34 are recesses formed in portions of the respective inner peripheral surfaces 32b of the sub frame 32 or protrusions protruding from portions of the respective inner peripheral surfaces 32b. In this configuration, the sub frame 32 includes the inner peripheral surfaces 32b that are the opposing surfaces opposite the respective peripheral surfaces 16e of the light guide plate 16 adjacent to the light entrance surface 16b. Light that leaks through the peripheral surfaces 16e of the light guide plate 16 are blocked by the inner peripheral surfaces 32b, namely, by the opposing surfaces. Therefore, light use efficiency can be improved. This configuration is preferable for increasing brightness. Furthermore, the inner peripheral surfaces 32b of the sub frame 32, which are the opposing surface opposite the peripheral surfaces 16e of the light guide plate 16 adjacent to the light entrance surface 16b, include the positioning portions 34 at portions thereof, respectively. The positioning portions 34 and the respective mating portions 33 at the peripheral surfaces 16e of the light guide plate 16 are fitted together. Therefore, the light guide plate 16 is positioned in the arrangement direction.

The backlight unit 12 includes the LED boards (a light source board) 18 including the opposing surfaces opposite the light entrance surfaces 16b. Multiple LEDs 17 are arranged in a line on the opposing surfaces of the LED boards 18. Each heat dissipation member 19 has a plate-like shape extending parallel to the plate surface of the LED board 18. The heat dissipation member 19 is attached to the LED board 18 so as to contact the plate surface of the LED board 18 on the opposite side from the LEDs 17 side. The restriction portion 35 protrudes from the heat dissipation member 19 toward the light guide plate 16 at the end with respect to the direction in which the heat dissipation member 19 extends. In this configuration, the LED boards 18 are mounted to the heat dissipation members 19 having a plate-like shape and extending parallel to the plate surfaces of the LED boards 18. The restriction portions 35 protrude from the ends of the extension dimension of the heat dissipation members 19 toward the light guide plate 16. Therefore, a distance between the LEDs 17 and the light entrance surface 16b is controlled.

The LED boards 18 have the elongated shape. The board connectors (a power feeding component) 22 to feed power to the LEDs 17 are disposed at ends of the longitudinal dimension of the LED boards 18, respectively. Each restriction portion 35 includes the lateral portion 35a and the restriction piece 35b. The lateral portion 35a protrudes from the end of the heat dissipation member 19 toward the light guide plate 16 and is beside the LED board 18 and the board connector 22. The restriction portion 35b protrudes at an angle from the distal end of the lateral portion 35a and sandwiched between the first side-surfaces 33a and 34b, which are the opposing surfaces of the positioning portion 34 and the mating portion 33 opposite to each other in the arrangement direction. In this configuration, power is fed to the LEDs 17 through the board connectors 22 disposed at the longitudinal ends of the respective LED boards 18. The lateral portions 35a of the restriction portions 35 protrude from the ends of the heat dissipation members 19 toward the light guide plate 16 and are beside the LED boards 18 and the board connectors 22, respectively. With this configuration, the board connectors 22 can be protected by the lateral portions 35. The restriction pieces 35b protrude from the distal ends of the lateral portions 35a, respectively. The restriction pieces 35b are sandwiched between the first respective side-surfaces 33a and 34a, which are the opposing surfaces of the positioning portions 34 and the mating portions 33 opposite to each other in the arrangement direction. Therefore, the distance between the LEDs 17 and the light entrance surface 16b is controlled.

The end portion of the light guide plate 16 includes the cutouts 16d that are formed in a part of the end portion including the light entrance surface 16b for receiving the respective board connectors 22. The mating portions 33 are adjacent to the respective cutouts 16d. In this configuration, one of the end portions of the light guide plate 16 including the light entrance surface 16b has the cutouts 16d at a part thereof to receive the board connectors 22. In comparison to a configuration in which the board connectors 22 are disposed between the light entrance surface 16b and the LED board 18 without cutouts, a distance between the LEDs 17 and the light entrance surface 16b can be reduced. Therefore, light entrance efficiency of light that enters the light entrance surface 16b can be improved. Furthermore, because the mating portions 33 are adjacent to the respective cutouts 16d, light exiting the LEDs 17 and traveling toward the mating portions 33 is more likely to be blocked by the board connectors 22 before light reaches the mating portions 33. Therefore, light is less likely to leak from the mating portions 33 and uneven brightness is suitably reduced.

### Second Embodiment

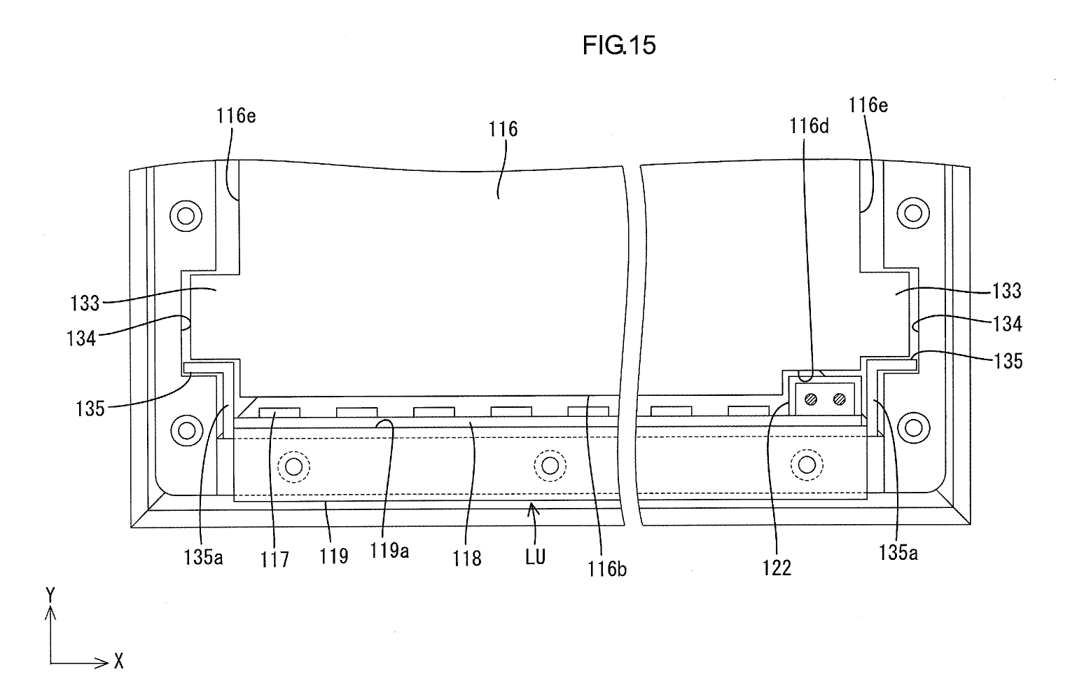

A second embodiment of this invention will be described with reference to FIG. 15. In the second embodiment, the numbers of an LED board 118 and a board connector 122 are different from the first embodiment. Configurations, functions, and effects similar to the first embodiment will not be described.

As illustrated in FIG. 15, an LED unit LU according to this embodiment includes an LED board 118 and a heat dissipation member 119. Each of the LED board 118 and the heat dissipation member 119 has a long dimension substantially the same as a long dimension of a light guide plate 116. The LED unit LU includes one board connector 122 that is disposed at an end portion of the long dimension of the LED board 118 (i.e., the right end portion in FIG. 15). Accordingly, the light guide plate 116 includes one cutout 116d at a corner of a long-side end portion thereof. The long-side end portion of the light guide plate 116 includes the light entrance surface 116b. Mating portions 133 are formed on peripheral surfaces 116e at the short sides of the light guide plate 116, respectively. More specifically, each mating portion 133 is located at an end of the corresponding peripheral surface 116e closer to the LED unit LU. Two restriction portions 135 are located at ends of a longitudinal dimension of an LED mounting portion 119 of the heat dissipation member 119. One of the restriction potions 135 on the right side in FIG. 15 has similar configurations to those of the restriction portions 35 of the first embodiment. The other restriction portion on the left side in FIG. 15 is arranged such that a lateral portion 135a of the restriction portion 135 is side by side with the end portion of the LED board 118 and one of LEDs 117 closest to the end of the LED board 118.

### Third Embodiment

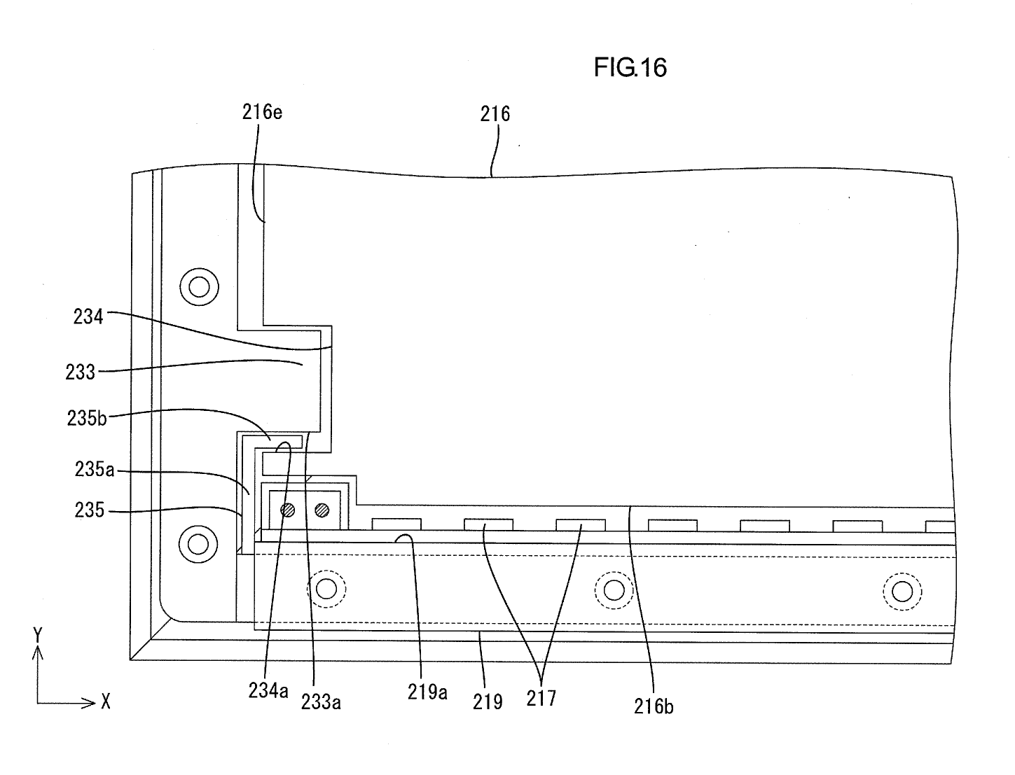

A third embodiment of this invention will be described with reference to FIG. 16. In the third embodiment, the projection-and-recess relations between mating portions 233 and positioning portions 234 are reversed from the first embodiment. Configurations, functions, and effects similar to the first embodiment will not be described.

As illustrated in FIG. 16, the mating portions 233 according to this embodiment are recesses formed in portions of short-side surfaces 216e of a light guide plate 216, respectively. The positioning portions 234 are protrusions formed on inner peripheral surfaces 232b of short-side portions of a sub frame 232, respectively. Each positioning portion 234 protrudes from a portion of the corresponding inner peripheral surface 232b toward an inner side, that is, toward a light guide plate 216. Restriction portions 235 include lateral portions 235a and restriction pieces 235b. Each lateral portion 235a protrudes from a corresponding end of a long dimension of the LED mounting portion 219b of a heat dissipation member 219 toward the light guide plate 216. Each restriction piece 235b projects at an angle from a distal end of the corresponding lateral portion 235a and extends along the X-axis direction toward an inner side. The restriction piece 235b is fitted in the mating portion 233, which is a recess, together with the positioning portion 234, which is a protrusion. The mating portion 233 and the positioning portion 234 include first side-surfaces 233a and 234a, respectively, located closer to LEDs 217. The restriction piece 235b is sandwiched between the first side-surfaces 233a and 234a, and thus a distance between the LEDs 217 and a light entrance surface 216b of the light guide plate 216 is controlled.

### Reference Example

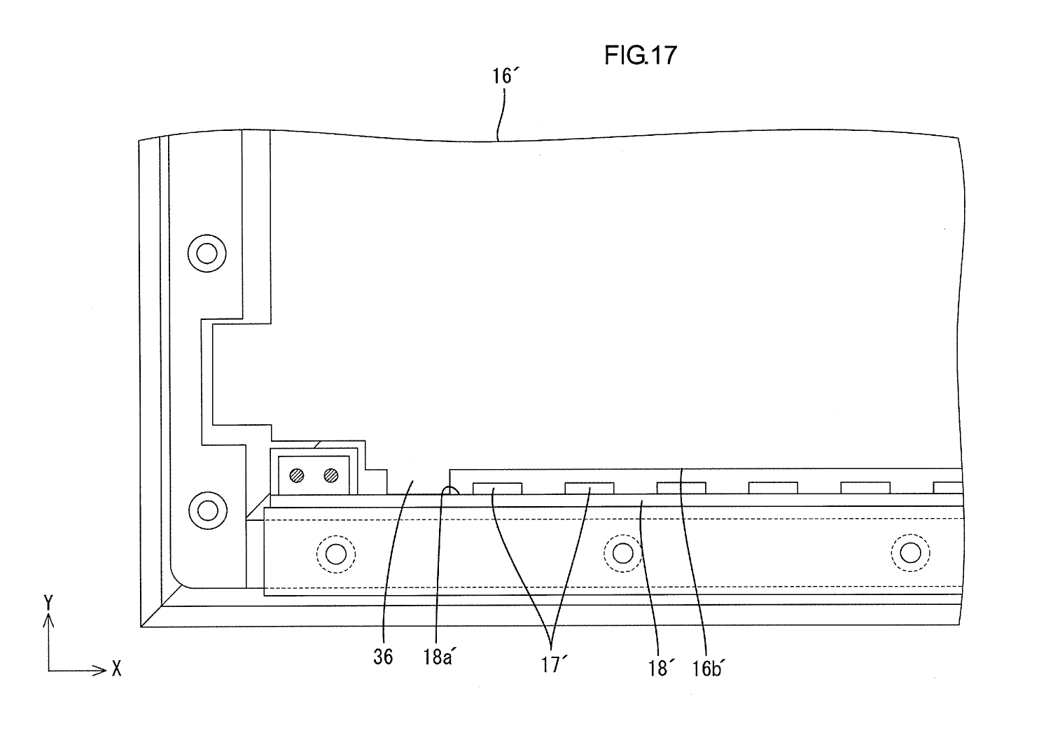

A reference example will be described with reference to FIG. 17. As illustrated in FIG. 17, a light guide plate 16′ according to this reference example includes a restriction portion 36 that is integrally formed with other portions thereof. The restriction portion 36 restricts a distance between a light entrance surface 16b′ and LEDs 17′ on an LED board 18′. The restriction portion 36 has a substantially block-like shape and protrudes from the light entrance surface 16b′ of the light guide plate 16′ toward the LED board 18′. A distal end surface of the restriction portion 36 is in contact with a mount surface 18a′ of the LED board 18′. With this configuration, the distance between the LEDs 17′ and the light entrance surface 16b′ is less likely to vary, and thus efficiency of light that enters the light entrance surface 16b′ can be improved and maintained.

### Other Embodiments

The present invention is not limited to the embodiments described in the above description and the drawings. The scope of the present invention includes the following embodiments.

(1) In each of the above embodiments, the restriction piece of each restriction portion is sandwiched between the first side-surface of the corresponding mating portion close to the LEDs and the first side-surface of the corresponding positioning portion close to the LEDs. However, the restriction piece may be sandwiched between the first side-surface of the mating portion away from the LEDs and the first side-surface of the positioning portion away from the LEDs by modifying the length or the shape of the restriction portion.

(2) In each of the above embodiments, the mating portions and the positioning portions are located close to the LEDs in the Y-axis direction. However, the position of each of the mating portion and the positioning portion in the Y-axis direction can be altered as appropriate. For example, the mating portion and the positioning portion may be at the middle portion of the light guide plate in the Y-axis direction and the middle portion of the sub frame in the Y-axis direction, respectively, or at the end portion of the light guide plate away from the LEDs and at the end portion of the sub frame away from the LEDs, respectively.

(3) In each of the above embodiments, each of the mating portion and the positioning portion has the vertical rectangular shape in a plan view. However, the mating portion and the positioning portion may have the horizontal rectangular, square, triangular, or trapezoidal shape in a plan view. Corresponding to shape changes in the mating portion and the positioning portion, the shape of the restriction portion (the restriction pieces portion, particularly) may be changed as appropriate.

(4) Each of the above embodiments includes two mating portions and two positioning portions. However, the number of each of the mating portion and the positioning portion may be one or three or more.

(5) In each of the above embodiments, the sub frame includes the positioning portion formed integrally with other portions thereof. However, the frame may include the positioning portion formed integrally with other portions thereof. The chassis may include the positioning portion formed integrally with other portions thereof. If the frame or the chassis includes the positioning portions, short-side portions of the frame or the chassis (i.e., a portion facing the mating portion of the light guide plate) may include the positioning portions.

(6) Other than the above embodiment (5), the positioning portions may be components different from the sub frame, the frame, and the chassis. Such components may be fixed to one of the sub frame, the frame, and the chassis with screw members or other fixing members.

(7) In each of the above embodiments, the sub frame made of synthetic resin is mounted to the frame made of metal. However, the embodiment may not include the sub frame. In such a configuration, the frame may suitably include the configurations of the sub frame (the light guide plate holding portion or the positioning portion). Suitable material for such a frame is metal in terms of achieving appropriate strength.

(8) In the above embodiments, one LED unit includes two LED boards and two heat dissipation members, or one LED unit includes one LED board and one heat dissipation member. However, one LED unit may include three or more than three LED boards and heat dissipation members.

(9) In each of the above embodiments, the LED unit includes the heat dissipation member. However, the LED unit may not include the heat dissipation member. In such a configuration, the LED board may include the restriction portion.

(10) In each of the above embodiments, the light guide plate includes the cutout to arrange the board connector therein. However, the light guide plate may not include the cutout if a proper space can be allocated between the light entrance surface and the LED board or the board connector is arranged on the lateral side of the light guide plate.

(11) In each of the above embodiments, the frame and the chassis are exterior members that provide an outer appearance of the liquid crystal display device. However, according to the present invention, a separate exterior member that covers a rear surface of the chassis may be provided such that the chassis is not exposed to the outside. Alternatively, a separate exterior member that covers both of the frame and the chassis may be provided such that the frame and the chassis are not exposed to the outside.

(12) In each of the above embodiments, the chassis and the frame that are the exterior members are made of metal. However, one or both of the chassis and the frame may be made of synthetic resin. This configuration is preferably applied to a medium-size or small-size liquid crystal display device that does not require very high mechanical strength.

(13) In each of the above embodiments, the power source board is configured to supply the power to the LED. However, an LED drive board that is configured to supply the power to the LED may be provided as a separate member from the power source board.

(14) In each of the above embodiments, the main board includes the tuner. However, a tuner board including a tuner may be provided as a separate member from the main board.

(15) In each of the above embodiments, the color filter of the liquid crystal panel includes color portions in three colors, red, green, and blue. However, the color filter may include color portions in four or more colors.

(16) In each of the above embodiments, the LED is used as a light source. However, a light source other than the LED, such as an organic EL, may be used.

(17) In the above embodiments, TFTs are used as switching components of the liquid crystal display device. However, the technology described above can be applied to liquid crystal display devices including switching components other than TFTs (e.g. thin film diode (TFD)). The technology can be applied to not only color liquid crystal display devices but also black-and-white liquid crystal display devices.

(18) In each of the above embodiments, the liquid crystal display device including the liquid crystal panel as a display panel is used. However, the technology can be applied to display devices including other types of display panels.

(19) In each of the above embodiments, the television device including the tuner is used. However, the technology can be applied to a display device without a tuner.

### EXPLANATION OF SYMBOLS

10: liquid crystal display device (display device), 11: liquid crystal panel (display panel), 12: backlight unit (lighting device), 16, 116, 216: light guide plate, 16a:light exit surface, 16b, 116b, 216b: light entrance surface, 16d, 116d: cutout, 16e, 116e, 216e: peripheral surface, 17, 117, 217: LED (light source), 18, 118: LED board (light source board), 19, 119, 219: heat dissipation member (light source mounting member), 22, 122: board connector (power feeding component)), 32: sub frame (positioning member), 32b: inner peripheral surface (opposing surface), 33, 133, 233: mating portion, 34, 134, 234: positioning portion, 35, 135, 235: restriction portion, 35a, 135a, 235a: lateral portion, 35b, 235b: restriction piece, TV: television receiver.

1. A lighting device, comprising:
a light source;
a light guide plate including a peripheral surface and a plate surface, the peripheral surface facing the light source and being configured as a light entrance surface through which light from the light source enters the light guide plate, the plate surface being configured as a light exit surface through which light exits the light guide plate;
a mating portion protruding from a portion of a peripheral surface of the light guide plate adjacent to the light entrance surface of the light guide plate or the mating portion being a recess formed therein;
a positioning portion for positioning the light guide plate with respect to an arrangement direction of the light source and the light guide plate with the positioning portion and the mating portion fitted together;
a light source mounting member on which the light source is mounted; and
a restriction portion included in the light source mounting member for controlling a distance between the light source and the light entrance surface and sandwiched between an opposing surface of the mating portion and an opposing surface of the positioning portion opposite to each other in the arrangement direction.

2. The lighting device according to claim 1, wherein
the mating portion protrudes from the peripheral surface of the light guide plate adjacent to the light entrance surface of the light guide plate, and
the positioning portion has a recessed shape corresponding to an outline of the mating portion.

3. The lighting device according to claim 1, wherein
the opposing surface of each of the positioning portion and the mating portion includes two opposing surfaces,
each of the positioning portion and the mating portion includes one of the opposing surfaces closer to the light source and another opposing surface away from the light source with respect to the arrangement direction, and
the restriction portion is sandwiched between the opposing surfaces of the positioning portion and the mating portion closer to the light source.

4. The lighting device according to claim 1, wherein the mating portion is located close to a light source side of the peripheral surface that is adjacent to the light entrance surface of the light guide plate.

5. The lighting device according to claim 1, further comprising a positioning member including an opposing surface, the opposing surface being opposite the peripheral surface of the light guide plate adjacent to the light entrance surface, wherein
the positioning portion is a recess formed in a portion of the opposing surface of the positioning member or a protrusion protruding from a portion of the opposing surface of the positioning member.

6. The lighting device according to claim 1, further comprising a light source board including an opposing surface opposite the light entrance surface, wherein
the light source includes a plurality of light sources that are arranged in a line on the opposing surface of the light source board,
the light source mounting member has a plate-like shape extending along a plate surface of the light source board and is attached to the light source board so as to contact a plate surface of the light source board on an opposite side from the light sources, and
the restriction portion protrudes from the light source mounting member toward the light guide plate at an end with respect to a direction in which the light source mounting member extends.

7. The lighting device according to claim 6, wherein
the light source board has an elongated shape and a power feeding component for feeding power to the light sources is disposed at an end of a long dimension of the light source board, and
the restriction portion includes a lateral portion and a restriction piece, the lateral portion protruding from the end of the light source mounting member toward the light guide plate and being beside the light source board and the power feeding portion, the restriction piece extending from a distal end of the lateral portion at an angle and sandwiched between the opposing surfaces of the positioning portion and the mating portion opposite to each other in the arrangement direction.

8. The lighting device according to claim 7, wherein
the light guide plate includes a cutout in a part of an end portion including the light entrance surface, the cutout being for receiving the power feeding component, and
the mating portion is arranged adjacent to the cutout.

9. A display device comprising:
the lighting device according to claim 1; and
a display panel configured to provide a display using light from the lighting device.

10. The display device according to claim 9, wherein the display panel is a liquid crystal display panel including liquid crystals.

11. A television device comprising the display device according to claim 9.
